(19) United States
(12) Patent Application Publication
(10) Pub. No.: US 2015/0236517 A1
(43) Pub. Date: Aug. 20, 2015

(54) CONTACTLESS ELECTRIC POWER FEEDING SYSTEM

(71) Applicant: PANASONIC INTELLECTUAL PROPERTY MANAGEMENT CO., LTD., Osaka (JP)

(72) Inventors: Futoshi Deguchi, Fukuoka (JP); Kazuhiro Eguchi, Fukuoka (JP); Yasuhito Yuasa, Osaka (JP)

(73) Assignee: PANASONIC INTELLECTUAL PROPERTY MANAGEMENT CO., LTD., Osaka (JP)

(21) Appl. No.: 14/428,514

(22) PCT Filed: Sep. 18, 2013
(86) PCT No.: PCT/JP2013/005516

§ 371 Date: Mar. 16, 2015

(30) Foreign Application Priority Data
Sep. 18, 2012 (JP) 2012-204879
May 10, 2013 (JP) 2013-099940
May 10, 2013 (JP) 2013-099941

(51) Int. Cl. H02J 5/00

(52) U.S. Cl. CPC H02J 5/005

(57) ABSTRACT

Provided is a contactless electric power feeding system that allows a plurality of devices to be recharged at the same time. A feeding device includes a primary feeding coil and each receiving device includes a secondary receiving coil. Each coil forms a resonance circuit jointly with a capacitor, and the two resonance circuits are electro-magnetically coupled with each other to from a transmission circuit unit. A first impedance of an input end of the transmission circuit unit is matched with a second impedance of an output end of the transmission circuit unit by using a coupling efficient between the primary feeding coil and the secondary receiving coil, and the output impedance of a power supply unit for supplying electric power to the primary feeding coil is smaller than the first impedance.

### TECHNICAL FIELD

The present invention relates to a contactless electric power feeding system, and in particular to a technology for feeding electric power from a feeding unit to a receiving unit without requiring a physical contact between them.

### PRIOR ART

It is conventionally known to feed electric power from a feeding unit provided with a primary feeding coil to a receiving unit provided with a secondary receiving oil by using an electromagnetic coupling between the two coils as a contactless electric power feeding. As such a contactless electric power feeding does not require any electric contacts, water proofing can be accomplished without any difficulty. Also, the problems associated with the degradation and failures of electric contacts can be eliminated, and the coupling and uncoupling between a power feeder unit and a power receiver unit can be effected in a highly simple manner. The primary feeding coil and the secondary receiving coil are typically made by winding a coil wire around a core or a bobbin.

In a contactless power feeding system, a primary feeding coil and a secondary receiver coil are placed opposite to each other so as to maximize the efficiency of the electromagnetic coupling between the two coils. Electric power obtained from a commercial AC power outlet is converted into a high frequency AC power having a frequency of 20 to 600 kHz by using a high frequency inverter circuit, and the high frequency AC power is applied to the primary feeding coil. AC power is induced in the secondary receiving coil owing to the electro-magnetic coupling between the two coils, and this AC power is converted into DC power by a rectifying/smoothing circuit. The obtained DC power may be used for recharging rechargeable batteries, for instance.

Typically, a power receiving device such as a portable device incorporated with a secondary receiving coil is placed on a feeder table incorporated with a primary feeding coil to establish an electro-magnetic coupling between them, but it is known that a significant reduction in the efficiency of power transmission could occur depending on the positioning of the secondary receiving coil with respect to the primary feeding coil.

JP2009-247194A discloses a power feeder table including an upper plate for placing a power receiving device thereon, a power source coil provided under the upper plate on a moving mechanism that allows the power source coil to move along the lower surface of the upper plate, a position detector for detecting the position of a power receiving device placed on the upper plate and a control unit for moving the power source coil to the position immediately under the detected position of the power receiving device. As a result, no matter where on the upper plate the power receiving device is placed, the power source coil or the primary feeding coil is placed directly opposite to the secondary receiving coil of the power receiving device so that the electro-magnetic coupling between the primary feeing coil and the secondary receiving coil is maximized at all times.

JP2009-252970A discloses a contactless electric power feeding system in which three or more planar coils serving as primary feeding coils are arranged in a partly overlapping relationship on a same plane. Each planar coil is provided with a larger outer diameter than the secondary receiving coil. The primary feeding coils receive energizing currents having mutually different phases such that a moveable magnetic field can be created by appropriately adjusting the phases of the energizing currents of the primary feeding coils. Thereby, the magnetic field can be distributed evenly within a prescribed area without any dead zone. Therefore, a large surface area of the power feeder is made available for power transmission.

JP2010-268610A discloses a contactless battery charger that is configured to assign different priority levels to a plurality of battery operated devices that are placed on an area suitable for recharging, and selectively feed electric power to the battery operated devices so that a limited capacity of the power source can be best utilized. Battery operated devices having higher priority levels are recharged before those having lower priority levels.

In the contactless power feeding system disclosed in JP2010-11654A, the power transmission efficiency is improved in a power transmission circuit where a transformer having a coupling coefficient less than one electro-magnetically couples a primary circuit and a secondary circuit with each other. A capacitor is connected in series with each of the primary and secondary circuits so that the primary and secondary circuits have a same resonance frequency. The primary and secondary circuits are configures such that the product of the square of the coupling coefficient and the Q values of the primary and secondary circuits is one.

The contactless power feeding device disclosed in JP2009-247194A allows the optimum positioning of the power receiving device without the intervention of the user or allows “positioning free” power feeding to be performed. However, the moving mechanism is able to deal with only one power receiving device at a time, and recharging of multiple devices at the same or “multi recharging” cannot be achieved.

In the contactless power feeding system disclosed in JP2010-11654A, the magnetic field generated by the primary feeding coils can be varied without physically moving the primary feeding coils so that “positioning free” power feeding can be achieved. However, in this case also, in spite of a high manufacturing cost and an increased complexity of the system, only one power receiving device can receive a supply of electric power at a time so that “multi recharging” cannot be achieved.

The contactless power feeding system disclosed in JP2010-268610A allows a plurality of power receiving devices to be placed on the power feeding device provided with a plurality of primary feeding coils at the same time, and to be recharged without the intervention of the user. Therefore, positioning free recharging can be achieved, but only one of the primary feeding coils is energized at a time to recharge a particular secondary receiving coil of a high priority power receiving device so that “multi recharging” in a true sense cannot be achieved.

JP2010-11654A teaches how circuit parameters can be optimized under a prescribed condition, but does not provide any solution to the task of achieving “multi recharging”.

### BRIEF SUMMARY OF THE INVENTION

In view of such problems of the prior art, a primary object of the present invention is to provide a contactless electric power feeding system and a contactless electric power feeding device that allow a plurality of devices to be recharged at the same time.

A second object of the present invention is to provide a contactless electric power feeding system and a contactless electric power feeding device that allow a plurality of devices to be recharged at a high efficiency without regard to the number of devices to be recharged.

According to the present invention, such objects can be accomplished by providing a contactless electric power feeding device for feeding electric power to a power receiving device including a secondary receiving coil, comprising: a primary feeding coil; an impedance control circuit electrically connected to the primary feeding coil; and a power supply unit configured to supply electric power to the primary feeding coil via the impedance control circuit; wherein a first impedance of an input end of a transmission circuit unit including the primary feeding coil and the second receiving coil is matched with a second impedance of an output end of the transmission circuit unit by using a coupling efficient between the primary feeding coil and the secondary receiving coil, and the output impedance of the power supply unit is smaller than the first impedance.

The present invention also provides a contactless electric power feeding system for feeding electric power from a power feeding device to a power receiving device, comprising: a transmission circuit unit including a primary feeding coil and a secondary receiving coil; an impedance control circuit electrically connected to the primary feeding coil; a power supply unit configured to supply electric power to the primary feeding coil via the impedance control circuit; and a power receiving circuit for receiving electric power from the secondary receiving circuit; wherein a first impedance of an input end of the transmission circuit unit is matched with a second impedance of an output end of the transmission circuit unit by using a coupling efficient between the primary feeding coil and the secondary receiving coil, and the output impedance of the power supply unit is smaller than the first impedance.

The present invention is most suitable for use with multi charging applications, but can also be advantageously applied to single charging applications. According to the present invention, various circuit parameters are optimized and a favorable impedance matching is achieved between the input and output ends of the transmission circuit unit so that positioning free, multi charging can be achieved without complicating either the mechanical or electrical structure of the contactless electric power feeding system.

According to a certain aspect of the present invention, the primary feeding coil and the secondary receiving coil both form series resonance circuits or parallel resonance circuits.

According to another aspect of the present invention, a first inductance of the primary feeding coil is determined from the coupling efficient between the primary feeding coil and the secondary receiving coil, and the first inductance is determined from a second inductance of the secondary receiving coil. The first inductance may be determined from the second impedance.

According to a preferred embodiment of the present invention, the primary feeding coil comprises a helical coil. Thereby, the primary feeding coil provides a large area in which an electro-magnetic field is distributed in an even manner. The secondary receiving coil is wound around an axial line substantially in parallel with an axial line of the helical coil, and is preferably formed as a planar spiral coil so that the secondary receiving coil may be incorporated in a highly low-profile, compact manner.

The impedance control circuit may comprise a coil and a capacitor. The impedance control circuit is effective in reducing the impedance of the output end of the power supply unit which typically consists of an AC/DC inverter.

According to another preferred embodiment of the present invention, the transmission circuit unit further comprises a primary capacitor connected in series with the primary feeding coil to form a series resonance circuit and a secondary capacitor connected in series with the secondary receiving coil to form another series resonance circuit. In this case, the power supply unit supplies an AC electric power with an angular frequency of omega to the primary feeding coil, and the following relationships hold

omega*L1=Z1/k

omega*L2=Z2/k

where
L1 is an inductance of the primary feeding coil,
L2 is an inductance of the secondary receiving coil Lb,
Z1 is the first impedance,
Z2 is the second impedance and
k is the coupling coefficient.

According to yet another preferred embodiment of the present invention, the transmission circuit unit further comprises a primary capacitor connected in parallel with the primary feeding coil to form a parallel resonance circuit and a secondary capacitor connected in parallel with the secondary receiving coil to form another parallel resonance circuit. In this case, the power supply unit supplies an AC electric power with an angular frequency of omega to the primary feeding coil, and the following relationships hold

omega*L1=Z1*k

omega*L2=Z2*k

where
L1 is an inductance of the primary feeding coil,
L2 is an inductance of the secondary receiving coil Lb,
Z1 is the first impedance,
Z2 is the second impedance and
k is the coupling coefficient.

According to yet another aspect of the present invention, the present invention provides a contactless electric power feeding system for feeding electric power from a power feeding device to a power receiving device, comprising: a transmission circuit unit including a primary feeding coil and a secondary receiving coil; a power supply unit configured to supply electric power to the primary feeding coil via the impedance control circuit; and a power receiving circuit for receiving electric power from the secondary receiving circuit; wherein a first impedance of an input end of the transmission circuit unit is matched with a second impedance of an output end of the transmission circuit unit by using a coupling efficient between the primary feeding coil and the secondary receiving coil, and the transmission circuit unit further comprises a primary capacitor connected in series with one of the primary feeding coil and the secondary receiving coil to form a series resonance circuit and a secondary capacitor connected in parallel with the other of the primary feeding coil and the secondary receiving coil to form a parallel resonance circuit.

### BRIEF DESCRIPTION OF DRAWINGS

FIG. 1 is an exploded perspective view of a contactless electric power feeding system embodying the present invention;

FIG. 2a is a plan view of the primary feeding coil La and the secondary receiving coils Lb when the corresponding portable devices are placed on the table surface as seen in the directions indicated by IIa in FIG. 1;

FIG. 2b is a front view of the primary feeding coil La and the secondary receiving coils Lb when the corresponding portable devices are placed on the table surface as seen in the directions indicated by IIb in FIG. 1;

FIG. 3 is a block diagram showing the basic circuit structure of the contactless electric power feeding system of the first embodiment;

FIG. 4 is a circuit diagram showing a transmission circuit unit of FIG. 3 when performing multi feeding;

FIG. 5 is a circuit diagram similar to FIG. 4 showing a second embodiment of the present invention;

FIG. 6 is a perspective view showing a feeding table provided with a primary feeding coil and a portable device provided with a secondary receiving coil placed on a table surface of the feeding table;

FIG. 7 is a plan view showing a positional relationship between the portable device ad the feeder table;

FIG. 8 is a graph showing a change in a coupling coefficient when the secondary receiving coil is moved along the X axis in FIG. 7;

FIG. 9 is a Smith chart for the arrangement shown in FIG. 7;

FIG. 10 is a graph showing changes in S parameters in the arrangement shown in FIG. 7;

FIG. 11 is a view similar to FIG. 7 when two secondary receiving coils are placed on the primary feeding coil;

FIG. 12 is a graph showing changes in coupling coefficients when one of the secondary receiving coils is moved along the X axis in FIG. 11;

FIG. 13 is a Smith chart for the arrangement shown in FIG. 11;

FIG. 14 is a graph showing changes in S parameters in the arrangement shown in FIG. 11;

FIG. 15 is a view similar to FIG. 7 showing three secondary receiving coils being placed on the primary feeding coil;

FIG. 16 is a Smith chart for the arrangement shown in FIG. 15;

FIG. 17 is a graph showing changes in S parameters in the arrangement shown in FIG. 15;

FIG. 18 is a perspective view showing a third embodiment of the present invention;

FIG. 19 is an exploded perspective view showing a fourth embodiment of the present invention;

FIG. 20a is a perspective showing the primary feeding coil and two of the secondary receiving coils;

FIG. 20b is a front view as seen from the direction indicated by an arrow XXb in FIG. 20a;

FIG. 21a is a plan view of a primary feeding coil and secondary receiving coils of a first example for comparison;

FIG. 21b is a sectional view taken along line XXIb-XXIb in FIG. 21a;

FIG. 22 is a graph showing a change in a coupling coefficient when the secondary receiving coil is moved along the X axis in FIG. 21a;

FIG. 23 is a graph showing a change in an output voltage when the secondary receiving coil is moved along the X axis in FIG. 21a;

FIG. 24 is a block diagram showing the basic circuit structure of the contactless electric power feeding system of a sixth embodiment of the present invention;

FIG. 25 is a circuit diagram showing the transmission circuit unit of FIG. 24 when performing multi feeding;

FIG. 26 is a graph showing a change in a coupling coefficient when the secondary receiving coil is moved away from a central position along the X axis in the arrangement shown in FIGS. 24 and 25;

FIG. 27 is a Smith chart for the arrangement shown in FIGS. 24 and 25;

FIG. 28 is a graph showing changes in an S parameter in the arrangement shown FIGS. 24 and 25;

FIG. 29 is a Smith chart for a second example for comparison which is similar to the arrangement of the sixth embodiment but deviates therefrom in the selection of the circuit parameters of the secondary transmission circuit;

FIG. 30 is a graph showing changes in an S parameter in the second example for comparison;

FIG. 31 is a block diagram showing the basic circuit structure of the contactless electric power feeding system of a seventh embodiment of the present invention;

FIG. 32 is a circuit diagram showing the transmission circuit unit of FIG. 29 when performing multi feeding;

FIG. 33 is a graph showing a change in a coupling coefficient when the secondary receiving coil is moved away from a central position along the X axis in the arrangement shown in FIGS. 31 and 32;

FIG. 34 is a Smith chart for the arrangement shown in FIGS. 31 and 32;

FIG. 35 is a graph showing changes in an S parameter in the arrangement shown FIGS. 31 and 32;

FIG. 36 is a Smith chart for a third example for comparison which is similar to the arrangement of the seventh embodiment but deviates therefrom in the selection of the circuit parameters of the secondary transmission circuit; and

FIG. 37 is a graph showing changes in an S parameter in the third example for comparison.

### DETAILED DESCRIPTION OF THE PREFERRED EMBODIMENTS

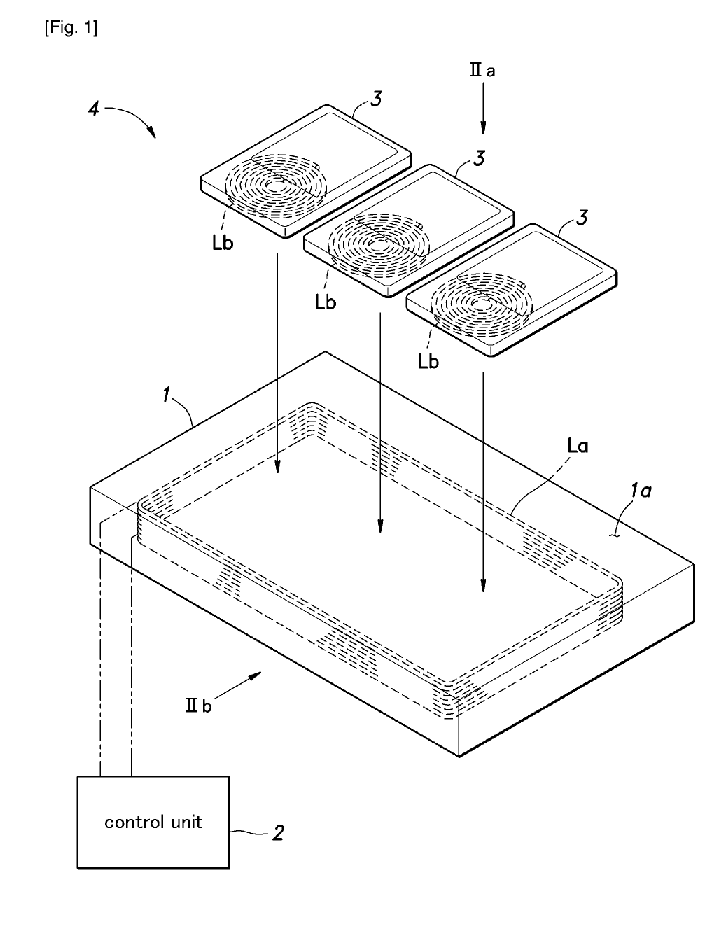

FIG. 1 is an exploded perspective view showing a contactless electric power feeding system embodying the present invention. This system includes a feeder table 1 defining a rectangular surface 1a thereon, and one or a plurality of portable devices 3 such as mobile phones (power receiving devices) may be placed on the table surface 1a. The feeder table 1 forms an electric power feeding device 4 jointly with an associated control unit 2. The feeder table 1 is internally provided with a primary feeding coil La consisting of a rectangular helical coil having a vertical axial line and including a coil wire extending along the peripheral part of the feeder table 1 in an ascending (descending) spiral. Each portable device 3 is internally provided with a secondary receiving coil Lb consisting of a flat spiral coil extending in a plane in parallel with the table surface 1a when the portable device 3 is placed on the table surface 1a.

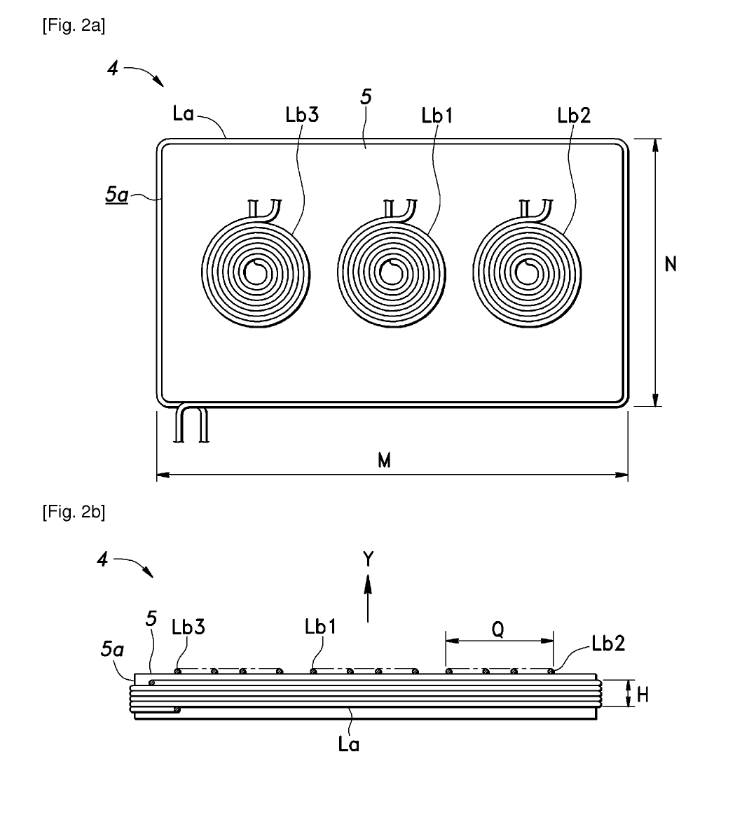

FIG. 2a is a plan view as seen in the direction indicated by IIa in FIG. 1, and FIG. 2b is a front view as seen in the direction indicated by IIb in FIG. 1. These drawings show the primary feeding coil La and the secondary receiving coils Lb when the corresponding portable devices 3 are placed on the table surface 1a. The primary feeding coil La is wound around a peripheral surface 5a of a retaining member 5 consisting of a rectangular plate member as a helical coil having a vertical axial line which is perpendicular to the table surface 1a. As shown in FIGS. 2a and 2b, the primary feeding coil La has a long side of length M, a short side of length N and a height H. In this case, the primary feeding coil La has a single layer of coil winding. However, if desired, the primary feeding coil La may consist of two or more layers of coil winding.

When supplied with electric current, the primary feeding coil La generates a magnetic flux which is directed in the axial direction thereof (or in the Y direction in FIG. 2b) inside the loop thereof. The coil wire may consist of a single wire or a Litz wire which is formed by twisting or weaving a plurality of individually insulated thin wire strands. The number of turns of the primary feeding coil La may be determined by taking into account the size and shape of the feeder table 1 and the required coil inductance.

Each portable device 3 is provided with a rechargeable battery not shown in the drawing and a secondary receiving coil Lb for supplying electric power to the rechargeable battery. In FIG. 2a, only the secondary receiving coils Lb are shown while the remaining parts of the portable devices 3 are omitted from the illustration. The secondary receiving coil Lb is formed by winding a coil wire (linear conductor) into a spiral on a same plane with an outer diameter Q. The central axial line of the secondary receiving coil Lb extends in parallel with the axial line of the primary feeding coil La when the portable device 3 is placed on the table surface 1a so that the magnetic flux generated from the primary feeding coil La passes through the secondary receiving coil Lb in parallel with the axial center line thereof when the portable device 3 is placed on the table surface 1a.

In FIGS. 1 and 2, three portable devices 3 are placed on the table surface 1a of the feeding table 1, but the number of the portable devices 3 can be selected as desired. In a typical configuration, the length N of the short side of the primary feeding coil La is no more than four times the outer diameter Q of the secondary receiving coil Lb (N &lt;=4Q), and the length M of the long side of the primary feeding coil La is no more than six times the outer diameter Q of the secondary receiving coil Lb (M &lt;=6Q). Most preferably, the length N of the short side of the primary feeding coil La is no more than twice the outer diameter Q of the secondary receiving coil Lb, and the length M of the long side of the primary feeding coil La is no more than three times the outer diameter Q of the secondary receiving coil Lb. The number of the portable devices 3 that can be placed simultaneously on the table surface 1a can be increased as long as the portable devices 3 fit into the area of the table surface 1a.

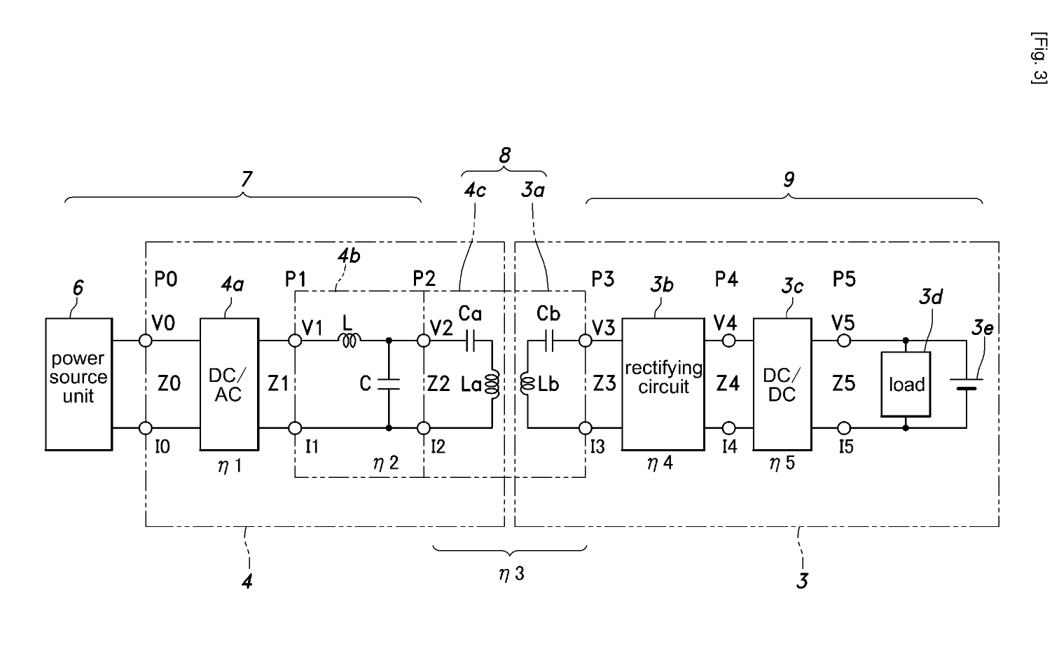

FIG. 3 shows the basic circuit structure of the contactless electric power feeding system of the illustrated embodiment. In addition to the primary feeding coil La, the electric power feeding device 4 comprises a DC/AC inverter 4a having an input end connected to an external power source unit 6, an LC circuit 4b including a coil L and a capacitor C connected in series across the output end of the DC/AC inverter 4a and a primary transmission circuit 4c including a primary resonance capacitor Ca and the primary feeding coil La connected in series across the capacitor C of the LC circuit 4b.

The power source unit 6 may include an AC/DC converter configured to convert commercial AC electric power into a DC electric power of a prescribed voltage. The DC electric power supplied from the electric power source 6 is converted into high frequency electric power of a prescribed angular frequency omega by the DC/AC inverter 4a, and the primary transmission circuit 4c is driven by this high frequency electric power. The DC/AC inverter 4a may include a clock generator IC for generating the switching frequency, a half-bridge gate driver IC and a pair of MOSFETs forming a switching circuit.

The portable device 3 incorporated with the secondary receiving coil Lb includes a secondary transmission circuit 3a consisting of the secondary receiving coil Lb and a secondary resonance capacitor Cb connected in series with the secondary receiving coil Lb, a rectifying circuit 3b connected to the output end of the secondary transmission circuit 3a, a DC/DC converter 3c connected to the output end of the rectifying circuit 3b and a load 3d and a rechargeable battery 3e connected to the output end of the DC/DC converter 3c.

An electric power feeding circuit unit 7 is formed by the power source unit 6, the DC/AC inverter 4a and the LC circuit 4b, and a transmission circuit unit 8 is formed by the primary transmission circuit 4c and the secondary transmission circuit 3a. An electric power receiving unit 9 is formed by the rectifying circuit 3b, the DC/DC converter 3c, the load 3d and the rechargeable battery 3e.

In this contactless electric power feeding system, high frequency electric power is supplied from the DC/AC inverter 4a to the primary feeding coil La via the LC circuit 4b, and AC electric power is induced in the secondary receiving circuit Lb owing to the electromagnetic induction caused between the primary feeding coil La and the secondary receiving coil Lb so that electric power is transmitted from the primary feeding coil La to the secondary receiving circuit Lb via the space separating them from each other.

In the electric power feeding device 4, a series resonance circuit is formed in the primary transmission circuit 4c by the primary feeding coil La and the primary resonance capacitor Ca. Owing to the changes in the magnetic flux generated in the primary feeding coil La by this series resonance circuit, an AC electric power is generated in the secondary receiving coil Lb by electromagnetic induction in dependence on the number of turns of the secondary receiving coil Lb.

In the electric power receiving unit 9 of the portable device 3, the rectifying circuit 3b consists of a diode bridge for total wave rectification and a smoothing capacitor, and converts the high frequency electric power supplied by the secondary transmission circuit 3a into DC electric power which is then forwarded to the DC/DC converter 3c. The DC/DC converter 3c converts the DC electric power supplied by the rectifying circuit 3b of the preceding stage into DC power of a prescribed voltage as required by the load (such as a recharging circuit) 3d and the rechargeable battery 3e. The recharging circuit that may be included in the load 3d for recharging the rechargeable battery 3e operates under a prescribed rated voltage and a prescribed rated electric power or electric current.

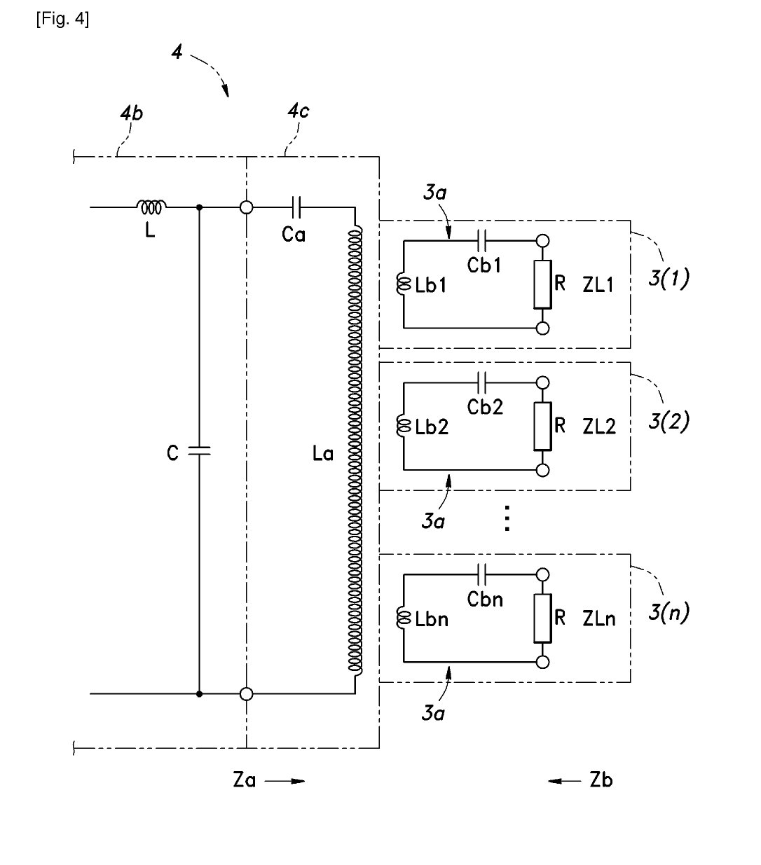

The circuitry for the multiple recharging in this contactless electric power feeding system is described in the following with reference to FIG. 4. In FIG. 4, the parts corresponding to those of FIG. 3 are denoted with like numerals without necessarily repeating the description of such parts.

As shown in FIG. 4, in the electric power feeding device 4, the primary feeding coil La and the primary resonance capacitor Ca jointly form the primary transmission circuit 4c, and the coil L and the capacitor jointly C form the LC circuit 4b. The primary transmission circuit 4c is connected to the output end of the LC circuit 4b. On the secondary side opposite to the primary feeding coil La, a plurality (n) of portable devices 3(1)-3(n) are placed, and the secondary receiving coil Lb1-Lbn of each portable device 3(1)-3(n) is connected in series with a secondary resonance capacitor Cb1-Cbn so as to form a series resonance circuit serving as the secondary transmission circuit 3a. In FIG. 4, the last suffix 1-n of the symbol for each component indicates the corresponding portable device to which the particular component belongs to, but each component may be collectively referred to the corresponding symbol by omitting this last suffix where appropriate.

In this embodiment, the primary resonance capacitor Ca is connected in series with the primary feeding coil Lam and the secondary resonance capacitor Cb is connected in series with the secondary receiving coil Lb so that the primary transmission circuit 4c and the secondary transmission circuit 3a both consist of series resonance circuits. Suppose that the secondary load impedances of the individual portable devices 3(1)-3(n) are given by ZL1-ZLn, if the primary transmission circuit 4c and the secondary transmission circuit 3a both consist of series resonance circuits, the overall secondary impedance Zb or the combined impedance of the portable devices can be given by the following equation.

Zb=1/{(1/ZL1)+(1/ZL2)+ . . . +(1/ZLn)} Eq(1)

Eq(1) shows that the overall secondary impedance Zb decreases with the increase in the number of the secondary devices or the portable devices 3.

The primary impedance Za of the electric power feeding device 4 can be given by the following equation.

Za=(omega<Sup>2</Sup>*M<Sup>2</Sup>)/Zb Eq(2)

where M is the mutual inductance.

From Eq(2), it can be seen that the primary impedance Za increases with the decrease in the secondary impedance Zb.

Thus, when the number of the portable devices 3 is increased, causing the secondary impedance Zb to drop and the primary impedance Za to increase, the electric power that can be drawn from the electric power feeding device 4 diminishes, and recharging of multiple portable devices 3 or multi recharging becomes more difficult.

However, according to the present invention, the electric power feeding device 4 is provided with the LC circuit 4b including the coil L connected in series with the primary transmission circuit 4c and the capacitor C connected in parallel with the primary transmission circuit 4c so that an impedance inversion control is achieved. When the overall impedance Zb of the secondary side has increased owing to the increase in the number of the portable devices 3 or the number of the user devices on the secondary side, the primary impedance Za increases as shown by Eq(2), but by virtue of the presence of the LC circuit 4b, the output impedance Z1 as seen from the DC/AC inverter 4a decreases. The decrease in the output impedance Z1 causes the output electric power P1 of the DC/AC inverter 4a to increase so that multiple recharging can be performed without incurring a shortfall in the supply of electric power from the electric power feeding device 4.

In regards to the circuit shown in FIG. 3, the design principle in achieving an impedance matching is described in the following. Eta1-eta5 indicated in the diagram of FIG. 3 denote the power transmission efficiencies (%) of the DC/AC inverter 4a, the LC circuit 4b, the primary and secondary transmission circuits 4c and 3a, the rectifying circuit 3b and the DC/DC converter 3c. P0-P5, V0-V5, J0-I5 and Z0-Z5 denote the output powers (W), the output voltages (V), the output currents (A) and the impedances (ohm) of the DC/AC inverter 4a, the LC circuit 4b, the primary and secondary transmission circuits 4c and 3a, the rectifying circuit 3b and the DC/DC converter 3c, respectively.

The current supplied to the load 3d and the rechargeable battery 3e and the combined impedance thereof can be obtained from the power and voltage requirements P5 and V5 of the load 3d and the rechargeable battery 3e by the following equations, respectively.

I5=P5/V5

Z5=/I5

The output impedance of the DC/DC converter 3c is desired to be matched with the combined impedance Z5 of the load 3d and the rechargeable battery 3e. The output voltage of the DC/DC converter 3c is the input voltage V5 of the load 3d and the rechargeable battery 3e, the output current of the DC/DC converter 3c is the input current I5 of the load 3d and the rechargeable battery 3e, and the output power of the DC/DC converter 3c is the input power P5 of the load 3d and the rechargeable battery 3e.

As the electric power transmission efficiency of the DC/DC converter 3c is eta5, the input power P4 of the DC/DC converter 3c is given by the following equation.

P4=P5/eta5

Given the input voltage V4 of the DC/DC converter 3c, the input current I4 and the input impedance Z4 of the DC/DC converter 3c are determined by the following equations.

I4=P4/V4

Z4=V4/I4

As the power transmission coefficient (AC/DC conversion efficiency) of the rectifying circuit 3b is eta4, the input power P3 of the rectifying circuit 3b can be given by the following equation.

P3=P4/eta4

Given the input voltage V3 of the rectifying circuit 3b, the input current I3 and the input impedance Z3 of the rectifying circuit 3b are determined by the following equations.

I3=P3/V3

Z3=V3/I3

As the input impedance Z3 of the rectifying circuit 3b is required to be matched with the output impedance of the transmission circuit unit 8, the output impedance of the transmission circuit unit 8 should be Z3. As the power transmission efficiency of the transmission circuit unit 8 is eta3, the input power P2 of the transmission circuit unit 8 is given by the following equation.

P2=P3/eta3

Given the impedance Z2 of the transmission circuit unit 8, the input current I2 of the transmission circuit unit 8 is given by the following equation.

I2=SQRT(P2/Z2)

Here, SQRT(x)=x<Sup>1/2</Sup>

The input voltage V2 of the transmission circuit unit 8 is given by the following equation.

V2=SQRT(P2*Z2)

Then, the values of the circuit elements of the transmission circuit unit 8 such as L1 (inductance of the primary feeding coil La), L2 (inductance of the secondary receiving coil Lb), C1 (primary resonance capacitor) and C2 (secondary resonance capacitor) are determined.

If the input and output impedances Za and Zb of the transmission circuit unit 8 and the coupling coefficient k between the primary feeding oil La and the secondary receiving coil Lb are given, the input and output impedances Za and Zb and the resonance angular frequency omega are related to one another according to the following equations.

La=Za/(omega*k)

Lb=Zb/(omega*k)

C1=1/(La*omega<Sup>2</Sup>)

C2=1/(Lb*omega<Sup>2</Sup>)

As the power transmission efficiency of the LC circuit 4b is eta2, the input power P1 thereof is given by the following equation.

P1=P2/eta2

Given the input impedance Z1 of the LC circuit 4b, the input current is given by the following equation.

I1=SQRT(P1/Z1)

The input voltage V1 thereof is given by the following equation.

V1=SQRT(P1*Z1)

With the input power P1, the output voltage V1 and the output current I1 of the

DC/AC inverter 4a thus determined, if the power transmission efficiency of the DC/AC inverter 4a is eta1, the input power P0 of the DC/AC inverter 4a can be given by the following equation.

P0=P1/eta1

where P0 is the electric power supplied by the power source unit 6.

The impedance of the DC/AC inverter 4a is typically very low, close to zero ohm as most AC power sources are. The output power P1 of the DC/AC inverter 4a can be determined from the output voltage (RMS or effective value) V1 of the DC/AC inverter 4a and the input impedance Z1 of the LC circuit 4b according to the following equation.

P1=V1<Sup>2</Sup>/Z1

Hence, the output voltage V1 is given by the following equation.

V1=SQRT(P1*Z1)

In the case of a half bridge circuit, the effective value of the voltage V1 is one half of the power source voltage V0 or

V1=V0/2

The power supply at the power source voltage V0 is given by the following equation.

P1=V0<Sup>2</Sup>/(4*Z1)

Based on such relationships, the circuit illustrated in FIG. 4 can thus be used advantageously in the diagram of FIG. 3.

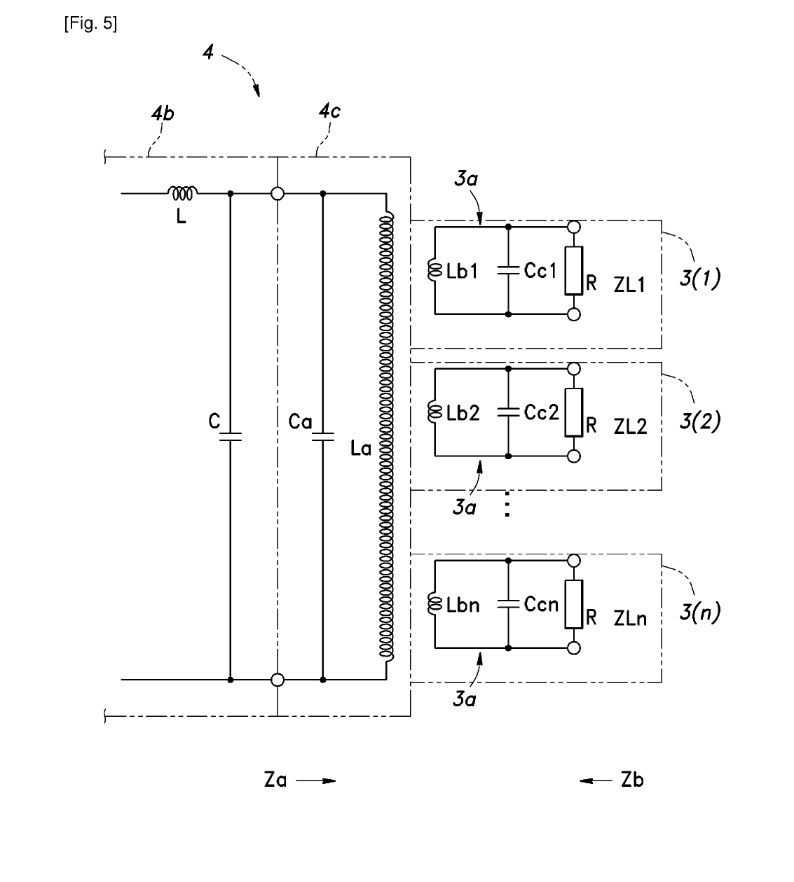

The primary transmission circuit 4c of the first embodiment formed a series resonance circuit because the secondary transmission circuit 3a of each portable device 3 on the power receiving end formed a series resonance circuit. However, it is also possible that the secondary transmission circuit 3a of each portable device 3 on the power receiving end forms a parallel resonance circuit. A primary transmission circuit 4c suitable for use in combination with portable devices 3 each using a parallel resonance circuit for the secondary transmission circuit 3a is described in the following with reference to FIG. 5. In the description of the circuit shown in FIG. 5, the parts corresponding to those of the previous embodiment illustrated in FIG. 4, for instance, are denoted with like numerals without necessarily repeating the description of such parts.

In the second embodiment illustrated in FIG. 5, the primary transmission circuit 4c is formed as a parallel resonance circuit consisting of the primary transmission coil La and the primary resonance capacitor Ca. To this primary transmission circuit 4c is connected an LC circuit consisting of a capacitor C and a coil L similarly as in the first embodiment.

Each of the portable devices 3(1)-3(n) in the second embodiment is provided with a secondary transmission circuit 3a formed by a parallel resonance circuit consisting of a secondary receiving coil Lb1-Lbn and a secondary resonance capacitor Cc1-Ccn connected in parallel thereto. When each secondary transmission circuit 3a is formed by a parallel resonance circuit in this manner, it is preferable to form the primary transmission circuit 4a also as a parallel resonance circuit by connecting a primary resonance coil Ca in parallel with the primary feeding coil La. Suppose that the impedances of the input and output impedances of the transmission circuit unit 8 are Za and Zb, respectively, and the coupling coefficient between the primary feeding coil La and the secondary receiving coil Lb is k. The input and output impedances Za and Zb and the resonance angular frequency omega are related to one another according to the following equations.

La=Za*k/omega

Lb=Zb*k/omega

C1=1/(La*omega<Sup>2</Sup>)

C2=1/(Lb*omega<Sup>2</Sup>)

Similarly as in the first embodiment where the primary and secondary transmission circuits 4c and 3a are both formed by series resonance circuits, the overall secondary impedance Zb or the combine impedance of the portable devices can be given by the following equation.

Zb=1/{(1/ZL1)+(1/ZL2)+ . . . +(1/ZLn)} Eq(1)

where ZL1-ZLn are the secondary load impedances of the individual portable devices 3(1)-3(n).

Similarly as in the first embodiment, the overall secondary impedance Zb decreases with the increase with the number of the secondary devices or the portable devices 3. Similarly as in the first embodiment, the primary impedance Za of the electric power feeding device 4 can be given by the following equation.

Za=(omega<Sup>2</Sup>*M<Sup>2</Sup>)/Zb Eq(2)

where M is the mutual inductance.

Therefore, in the second embodiment also, the primary impedance Za increases with the decrease in the secondary impedance Zb.

Thus, when the number of the portable devices 3 is increased, causing the secondary impedance Zb to drop and the primary impedance Za to increase, the electric power that can be drawn from the electric power feeding device 4 diminishes, and recharging of multiple portable devices 3 or multi recharging becomes more difficult.

In this embodiment also, as shown in FIG. 5, the electric power feeding device 4 is provided with the LC circuit 4b including the coil L connected in series with the primary transmission circuit 4c and the capacitor C connected in parallel with the primary transmission circuit 4c so that an impedance inversion control is achieved.

When the overall impedance Zb of the secondary side has increased owing to the increase in the number of the portable devices 3 or the number of the user devices on the secondary side, the primary impedance Za increases as shown by Eq(2), but by virtue of the presence of the LC circuit 4b, the output impedance Z1 as seen from the DC/AC inverter 4a decreases. The decrease in the output impedance Z1 allows the output electric power P1 of the DC/AC inverter 4a to increase so that multiple recharging can be performed without incurring a shortfall in the supply of electric power from the electric power feeding device 4.

In addition to this impedance inversion control, the LC circuit 4b may serve as an LC low pass filter so that spurious emission of higher harmonic noises that could be caused by the switching operation of the DC/AC inverter 4a can be suppressed, and undesired EMI (electromagnetic interferences) can be minimized.

Thus, the present invention can be adapted to different resonance circuit configurations of the secondary transmission circuit 3a of each portable device 3, be it a parallel resonance circuit or a series resonance circuit. More specifically, two feeder tables 2 may be prepared so that each user may select either one of them depending on the particular configuration of the user's portable device. Advantageously, the portable devices and the feeder tables may be appropriately affixed with a marking indicating the configuration of the portable device or the feeder table so that each user may be enabled to readily know which of the feeder tables suits the user's particular portable device.

According to the conventional contactless electric power feeding systems, the transmission efficiency depended on which part of the feeder table the portable device is placed. For instance, a portable device placed on the central part of the feeder table is more efficiently or quickly recharged than another portable device placed on a peripheral part of the feeder table because of the positional variations in the levels of electromagnetic coupling. Also according to the conventional arrangement, when a large number of portable devices are placed on a feeder table, the output voltage of the output end of the feeder table may drop to such an extent that the portable devices may not be recharged within a reasonable period of time.

On the other hand, according to the present invention, without regard to where on the feeder table 1 having the primary feeing coil La a portable device 3 having the secondary receiving oil Lb is placed, be it a central part or a peripheral part thereof, the portable device 3 can be recharged at a high efficiency. Also, according to the present invention, a large number of portable devices 3 can be recharged at the same time without causing a shortfall in the supply of electric power from the electric power feeding device 4.

Details of the first embodiment are described in the following.

The arrangements of the primary feeding coil La and the secondary feeding coil Lb shown in FIG. 4, and the transmission circuit unit 8 shown in FIG. 3 were actually used for testing a contactless electric power feeding from the feeding device 4 and the portable device 3. FIG. 3 shows only the essential part of the transmission circuit unit 8, and a recharging circuit, a verification circuit, a temperature detecting circuit and so on with which the contactless electric power feeding system are provided with are omitted from illustration.

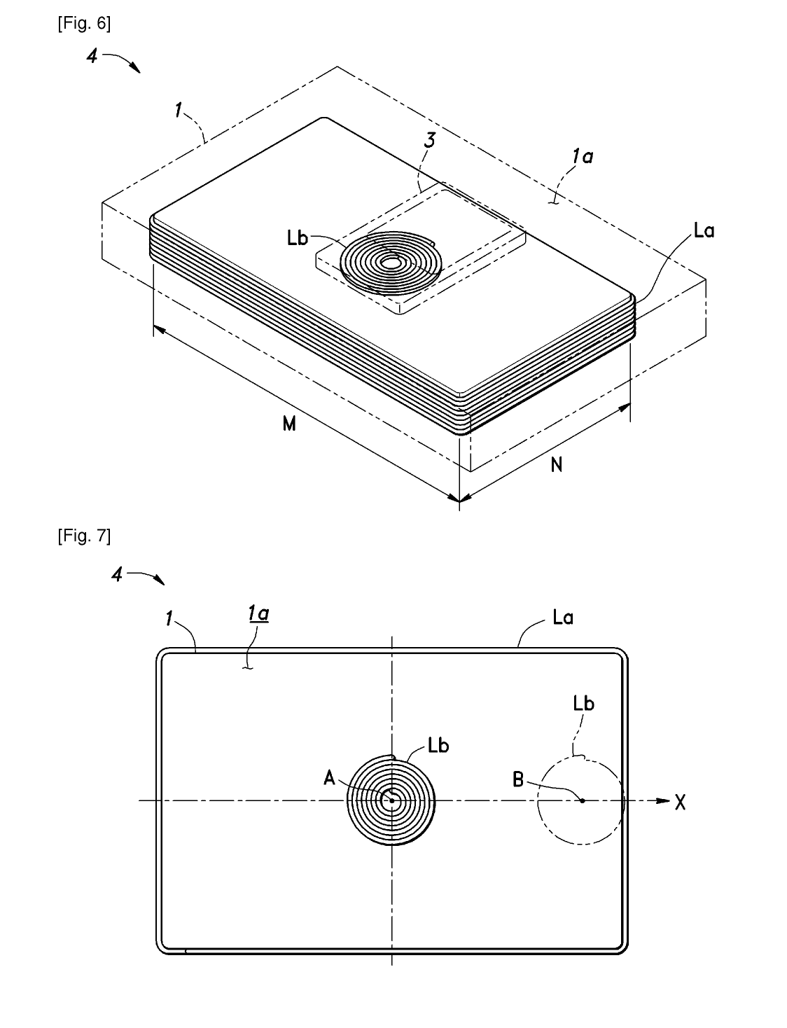

FIG. 6 shows a portable device 3 or a power receiving device placed on the table surface 1a of the feeder table 1 in the contactless electric power feeding system according to the present invention. FIG. 6 is similar to FIG. 1, but shows only one portable device 3 placed on the table surface 1a, instead of three portable devices 3. Again, FIG. 6 shows only the primary feeding coil La of the feeder table 1 and the secondary receiving coil Lb of the portable device 3.

The retaining member 5 was made of acrylic resin, and is formed as a plate member which is 240 mm long (M) along the long side thereof and 160 mm wide (N) along the short side thereof. The primary feeding coil La was formed by winding a copper coil wire of 0.8 mm diameter on the peripheral surface 1a of the retaining member by 21 turns as a helical coil of a single layer. As a result, the primary feeding coil La consisted of a rectangular coil measuring 240 mm (=M) by 160 mm (=N), and was given with a height H of about 16 mm. The secondary receiving coil Lb was formed by winding a copper coil wire of 0.8 mm diameter on a common plane as a spiral coil which has an inner diameter of 10 mm and an outer diameter of 40 mm (Q).

When the secondary receiving coil Lb was placed in the center of the primary feeding coil La, the coupling coefficient k between the primary feeding coil La and the secondary receiving coil Lb was 0.061. The transmission frequency omega was 150 kHz, the impedance Za of the power feeding circuit unit 7 was 11.8 ohms, and the impedance Zb of the transmission circuit unit 8 was 3.5 ohms. As the self inductance La of the primary feeding coil La is related to the impedance thereof such that La=Za/(omega*k), the capacitance Ca of the primary resonance capacitance can be given by the following equation.

Ca=1/(La*omega<Sup>2</Sup>)

Also, as the self inductance Lb of the secondary feeding coil Lb is related to the impedance thereof such that Lb=Zb/(omega*k), the capacitance Cb of the primary resonance capacitance can be given by the following equation.

Cb=1/(Lb*omega<Sup>2</Sup>)

Based on these relationships, the values of the various circuit elements were determined as given in the following. The self inductance La of the primary transmission coil La and the capacitance Ca of the primary resonance capacitor Ca of the primary transmission circuit 4c were 205.3 (micro H) and 5.5 (nF), respectively, and the self inductance Lb of the secondary transmission coil Lb and the capacitance Cb of the secondary resonance capacitor Cb of the secondary transmission circuit 3a were 60.9 (micro H) and 18.5 (nF), respectively. The transmission circuit unit 8 was constructed by using these circuit element values, and the transmission properties were measured by using a vector network analyzer (VNA).

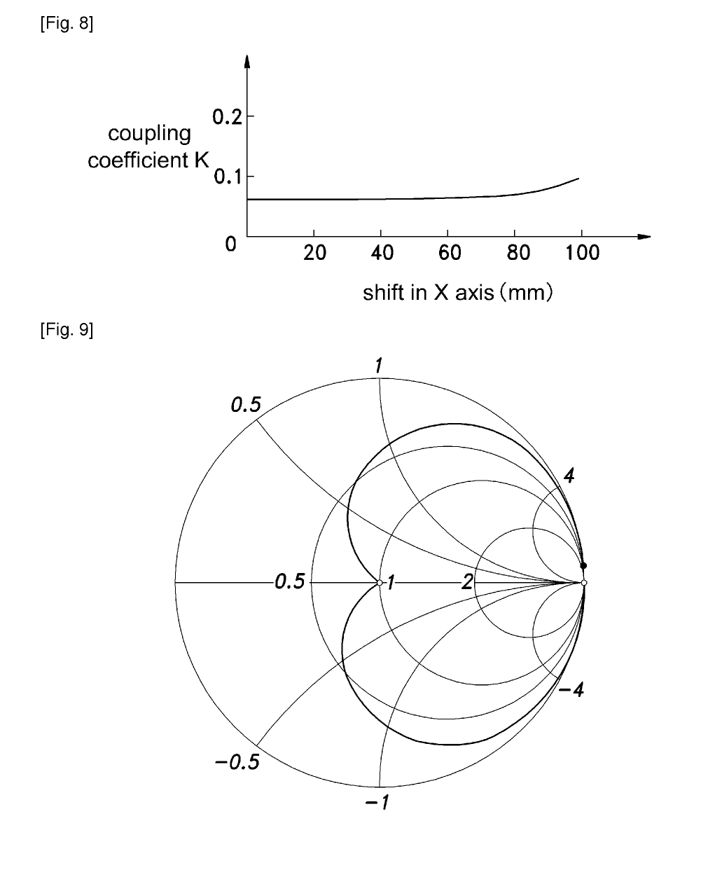

As shown in FIG. 7, the secondary transmission coil Lb was moved from a central position (position A or X=0) to a peripheral position (position B or X=100 mm). FIG. 8 shows the change in the coupling coefficient k as the secondary transmission coil Lb was moved from position A to position B. As can be seen from FIG. 8, there was very little change in the coupling coefficient k substantially without regard to the position of the secondary transmission coil Lb in the primary transmission coil La.

FIG. 9 is a Smith chart showing the properties of the impedance Za of the primary transmission circuit 4c (normalized by 11.8 ohms) as seen from the primary side of the primary transmission circuit 4c when the secondary transmission coil Lb was placed substantially in the center (position A).

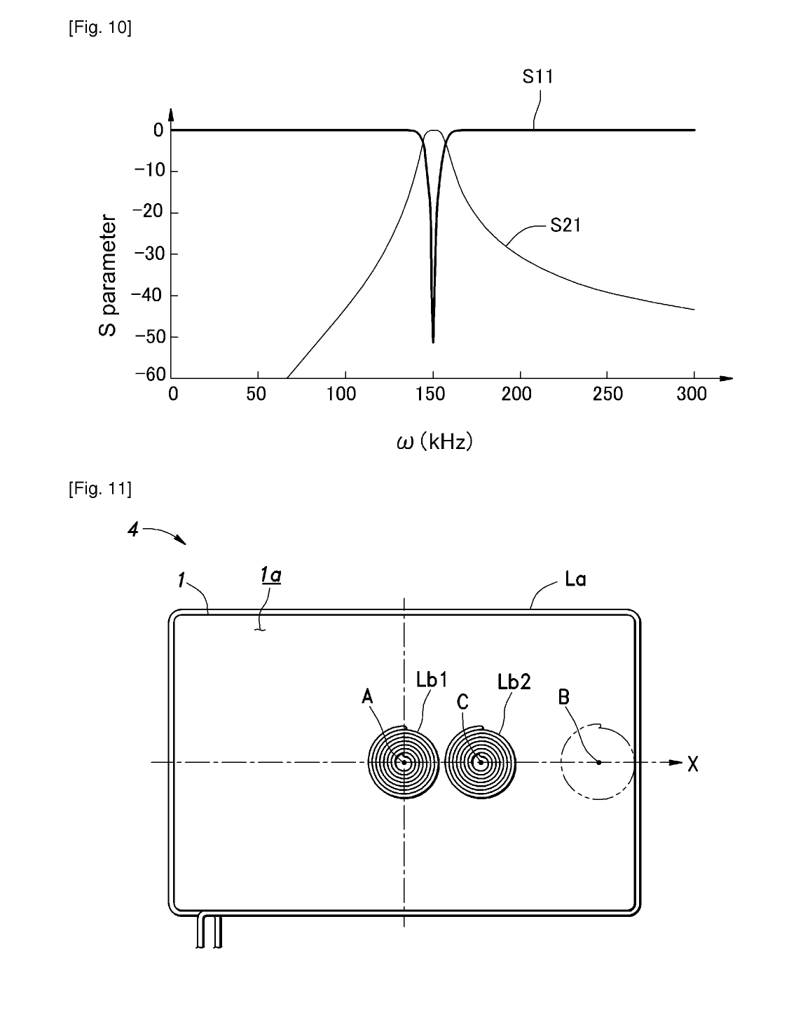

The reflection/transmission properties are shown in FIG. 10. As can be seen from FIG. 10, the reflective properties (S11) show an extremely small return loss of −51.3 dB (=20*log (0.0027)) at omega=150 kHz which indicates almost no reflection, and it means that a favorable impedance matching was achieved.

The transmission properties (S21) show an extremely small transmission loss of −0.004 dB (=20*log (0.999)) at omega=150 kHz which indicates almost no transmission loss.

As shown in FIG. 11, a first secondary transmission coil Lb1 (portable device 3(1)) was placed substantially in the center (position A) of the primary transmission coil

La, and a second secondary transmission coil Lb2 (portable device 3(2)) was placed at a position (position C) somewhat offset (by 40 mm) from the center (position A) of the primary transmission coil La along the X axis. In this case, the self inductances La and L2 of the primary transmission coil La and the second secondary transmission coil Lb2, respectively, and the capacitances Ca and C2 of the primary resonance capacitor Ca of the primary transmission circuit 4c and the resonance capacitor Cb2 of the secondary transmission circuit 3a, respectively are given by the following equations.

La=Za/(omega*k)

L2=ZL2/(omega*k)

Ca=1/(La*omega<Sup>2</Sup>)

C2=1/(L2*omega<Sup>2</Sup>)

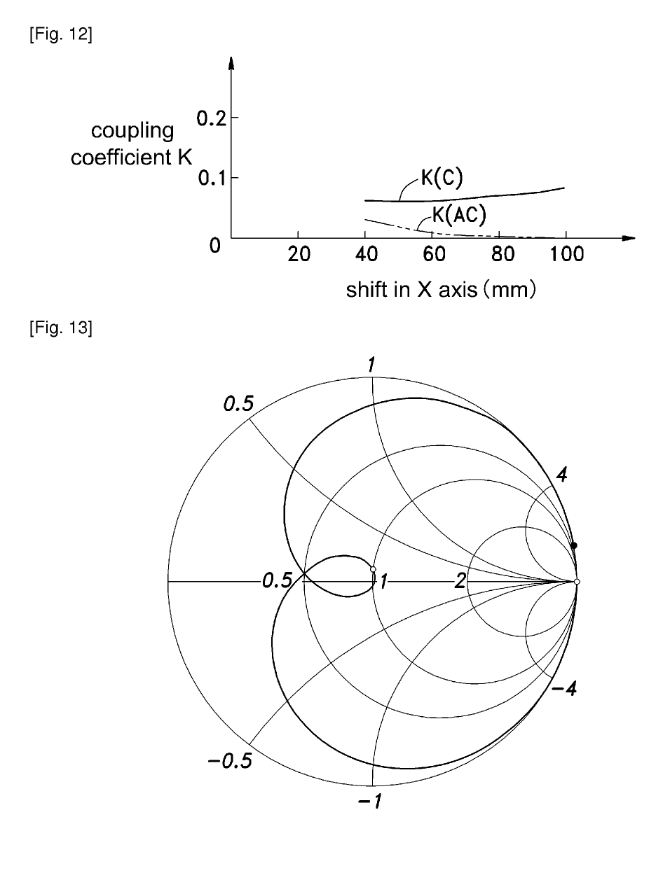

In FIG. 11, while the first secondary receiving coil Lb1 is placed at the center (position A), the other secondary receiving coil Lb2 is moved from the position offset from the center by 40 mm (position C) to the position offset from the center by 100 mm (position B). During this process, the change of the coupling coefficient k (C) between the primary feeding coil La and the secondary receiving coil Lb2, and the change of the coupling coefficient k (AC) between the first secondary receiving coil Lb1 and the second secondary receiving coil Lb2 were measured, and the results are shown in the graph of FIG. 12. It can be seen that there was very little change in the coupling coefficient k(C) between the primary feeding coil La and the secondary receiving coil Lb2 without regard to the position of the secondary receiving coil Lb2.

The coupling coefficient k (AC) between the first secondary receiving coil Lb1 placed at the center at X=0 (central position or position A) and the second secondary receiving coil Lb2 placed at X=40 mm (position C) is smaller than the coupling coefficient k(C) between the primary feeding coil La and the secondary receiving coil Lb2. The coupling coefficient k (AC) progressively approaches zero as the second secondary receiving coil Lb2 moves away from the first secondary receiving coil Lb1. It means that there is very little electromagnetic coupling between the two secondary receiving coils Lb1 and Lb2 placed in parallel to each other.

FIG. 13 is a Smith chart showing the properties of the impedance Za of the primary transmission circuit 4c (normalized by 11.8 ohms) as seen from the primary side of the primary transmission circuit 4c when the first secondary transmission coil Lb1 was placed substantially in the center (position A) and the second secondary transmission coil Lb2 was placed at a position (position C) next thereto at some distance from the center. Similarly as that in FIG. 9, this Smith chart shows the properties of the input impedance Za (which is normalized by 24.3 ohms) as seen from the electric power feeding circuit unit 7.

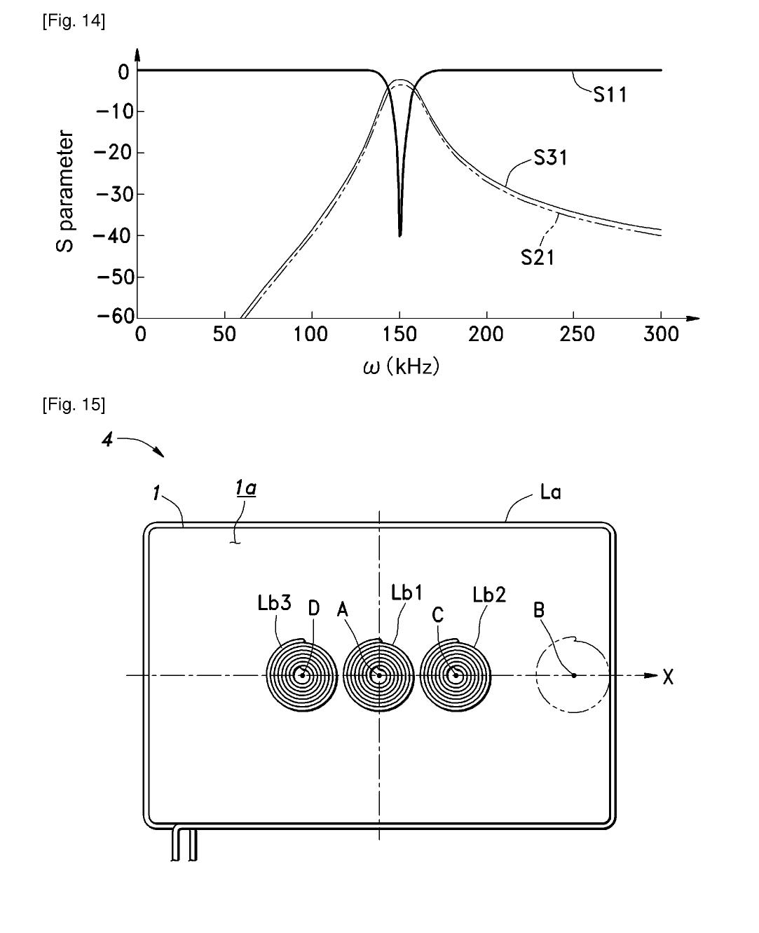

The reflection/transmission properties are shown in FIG. 14 which is similar to FIG. 10. As can be seen from FIG. 14, the reflective properties (S11) show a very small return loss of −26.1 dB (=20*log (0.0498)) at omega=150 kHz which indicates almost no reflection, and it means that a favorable impedance matching was achieved.

The transmission properties (S21) in the transmission to the first secondary receiving coil Lb1 show an extremely small transmission loss of −3.63 dB (=20*log (0.6574)) at omega=150 kHz which indicates almost no transmission loss. Also, the transmission properties (S31) in the transmission to the second secondary receiving coil Lb2 show an extremely small transmission loss of −2.48 dB (=20*log (0.7515)) at omega=150 kHz which indicates almost no transmission loss.

Referring to FIG. 15, a first secondary transmission coil Lb1 (portable device 3(1)) was placed substantially in the center (position A) of the primary transmission coil La, a second and third secondary transmission coil Lb2 and Lb3 (portable devices 3(2) and 3(3)) were placed at positions (position C and position D) somewhat offset from the center (position A) of the primary transmission coil La on either side along the X axis. In this case, the coupling coefficient k(A) between the primary transmission coil La and the first secondary transmission coil Lb1 was 0.062, the coupling coefficient k(C) between the primary transmission coil La and the second secondary transmission coil Lb2 was 0.064, and the coupling coefficient k(D) between the primary transmission coil La and the third secondary transmission coil Lb3 was 0.064. The coupling coefficient k(AC) between the first secondary transmission coil Lb1 and the second secondary transmission coil Lb2 was 0.033, the coupling coefficient k(AD) between the first secondary transmission coil Lb1 and the third secondary transmission coil Lb3 was 0.033, and the coupling coefficient k(CD) between the second secondary transmission coil Lb2 and the third secondary transmission coil Lb3 was 0.002.

In this case, the self inductances La and Ln (1, 2, 3) of the primary transmission coil La and the secondary transmission coils L1, L2, L3, respectively, and the capacitances Ca and Cn (1, 2, 3) of the primary resonance capacitor Ca of the primary transmission circuit 4c and the resonance capacitors Cb1, Cb2, Cb3 of the secondary transmission circuit 3a, respectively are given by the following equations similarly as in the relationships obtained in connection with the transmission circuit unit 8 consisting of the primary transmission circuit 4c and the secondary transmission circuit 3a.

La=Za/(omega*k)

L2=ZLn/(omega*k)

Ca=1/(La*omega<Sup>2</Sup>)

Cn=1/(Ln*omega<Sup>2</Sup>)

where n=1, 2, 3.

When the impedance matching is appropriately made between the primary feeding coil La and the secondary receiving coil Lb, the increase of the load as seen from the primary side is simply additive so that the design of the inverter circuit is simplified.

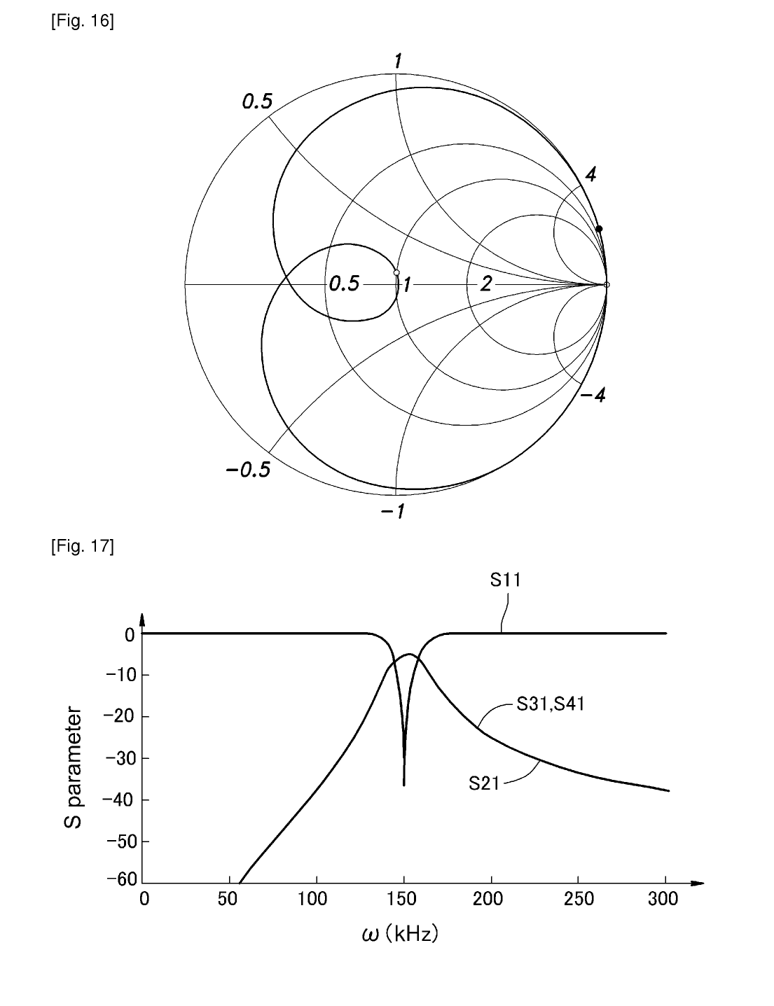

FIG. 16 is a Smith chart showing the properties of the impedance Za of the primary transmission circuit 4c as seen from the primary side of the primary transmission circuit 4c when the first secondary transmission coil Lb1 was placed substantially in the center (position A) and the second and third secondary transmission coils Lb2 and Lb3 were placed at positions (positions C and D) offset from the center (position A) of the primary transmission coil La on either side along the X axis. The properties of the input impedance Za (normalized by 38.4 ohms) are as seen from the electric power feeding circuit unit 7.

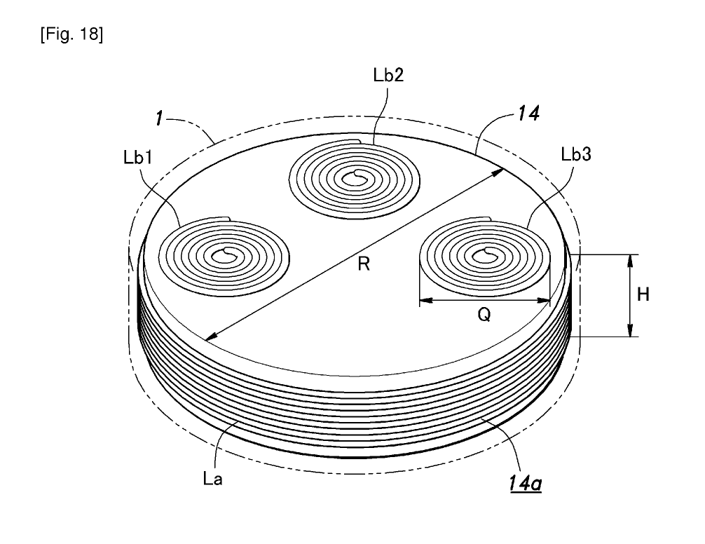

The reflection/transmission properties are shown in FIG. 17. As can be seen from FIG. 17, the reflective properties (S11) show a very small return loss of −22.9 dB (=20*log (0.0716)) at omega=150 kHz which indicates almost no reflection, and it means that a favorable impedance matching was achieved.

The transmission properties (S21, S31 and S41) were S21=−5.49 dB, S31=−4.48 dB and S41=−4.48 dB, and it means that the transmission losses were all substantially zero.

In the structure illustrated in FIG. 15, the state of the magnetic flux was investigated. States of strong magnetic coupling were observed in the magnetic flux distributions between the primary feeding coil La and the first secondary receiving coil Lb1, between the primary feeding coil La and the second secondary receiving coil Lb2, and between the primary feeding coil La and the third secondary receiving coil Lb3. On the other hand, no significant magnetic coupling was observed between the first secondary receiving coil Lb1 and the second secondary receiving coil Lb2, between the second secondary receiving coil Lb2 and the third secondary receiving coil Lb3, and between the first secondary receiving coil Lb1 and the third secondary receiving coil Lb3.

As the secondary receiving coils Lb1, Lb2 and Lb3 were matched with the primary feeding coil La in impedance, the phase of the magnetic flux was substantially the same for all of the secondary receiving coils Lb1, Lb2 and Lb3. As a result, the magnetic couplings between the secondary receiving coils Lb1, Lb2 and Lb3 were small.

When the three portable devices 3(1), 3(2) and 3(3) each containing a secondary receiving coil Lb were placed on the table surface 1a of the feeding table incorporated with the primary feeding coil La at different positions A, B and C, the portable device 3(1), 3(2), 3(3) were each enabled to receive a power supply of 10 Watts as required, and it was demonstrated that a plurality of portable devices can be simultaneously recharged according to the present invention.

By using a vertical helical coil for the primary feeding coil La and taking an impedance matching between the primary feeding coil and the secondary receiving coil(s), even when a plurality of secondary receiving coils Lb1-Lbn are placed on the primary feeding coil La, each secondary receiving coil can benefit from a substantially equal power transmission properties, and it was demonstrated that a favorable multi recharging can be accomplished.

When the values of the circuit parameters such as the resonance condition, the coupling coefficient and the input and output impedances of the transmission circuit unit 8 are properly selected, it is possible to arrive at a design point where the theoretical efficiency (disregarding the losses of the coils) of almost 100% can be achieved. If an appropriate impedance matching is made between the primary feeding coil La and the secondary receiving coil(s) Lb, the increase in the load (on the secondary side) as seen from the primary side is simply additive so that the design of the inverter circuit can be simplified.

As mentioned earlier, with the primary feeding coil La being of a rectangular configuration, it is preferable that the length N of the short side of the primary feeding coil La is no more than four times the outer diameter Q of the secondary receiving coil Lb (N &lt;=4Q), and the length M of the long side of the primary feeding coil La is no more than six times the outer diameter Q of the secondary receiving coil Lb (M &lt;=6Q). It is based on the fact that transmission efficiency tends to decrease when the length N of the short side of the primary feeding coil La is more than four times the outer diameter Q of the secondary receiving coil Lb. Also, even when the length N of the short side of the primary feeding coil La is no more than four times the outer diameter Q of the secondary receiving coil Lb (N &lt;=4Q), it was observed that the transmission efficiency tends to decrease when the length M of the long side of the primary feeding coil La is more than six times the outer diameter Q of the secondary receiving coil Lb. It was also observed that more favorable results can be obtained if the length N of the short side of the primary feeding coil La is no more than three times the outer diameter Q of the secondary receiving coil Lb (N &lt;=3Q), and the length M of the long side of the primary feeding coil La is no more than five times the outer diameter Q of the secondary receiving coil Lb (M &lt;=5Q). Most preferably, the length N of the short side of the primary feeding coil La is no more than twice the outer diameter Q of the secondary receiving coil Lb, and the length M of the long side of the primary feeding coil La is no more than three times the outer diameter Q of the secondary receiving coil Lb.

The present invention is not limited by the foregoing embodiments. A third embodiment of the contactless electric power feeding system of the present invention is described in the following.

FIG. 18 is a perspective view of the third embodiment of the present invention. The primary feeding coil La is formed by winding a helical coil around the peripheral surface 14a of a short cylindrical retainer 14 having a diameter R to a height H. This helical coil consists of a single layer of coil. The coil wire may be similar to that of the first embodiment. Again, if desired, the primary feeding coil La may also be wound in two or more layers of coil winding.

On this primary feeding coil La, in particular within an area surrounded by the helical coil as seen in plan view, three portable devices or three secondary receiving coils Lb1-Lb3 are placed. Each of the secondary receiving coils Lb1-Lb3 consists of a flat spiral coil similar to those of the previous embodiments, and the coil wire may also be similar to that of the first embodiment.

In the third embodiment, in order to achieve a practical power transmission efficiency, the diameter R of the primary feeding coil La may be no more than four times the diameter Q of the secondary receiving coils Lb. The transmission efficiency increases further if this ratio is no more than three, and even further if this ratio is no more than two.

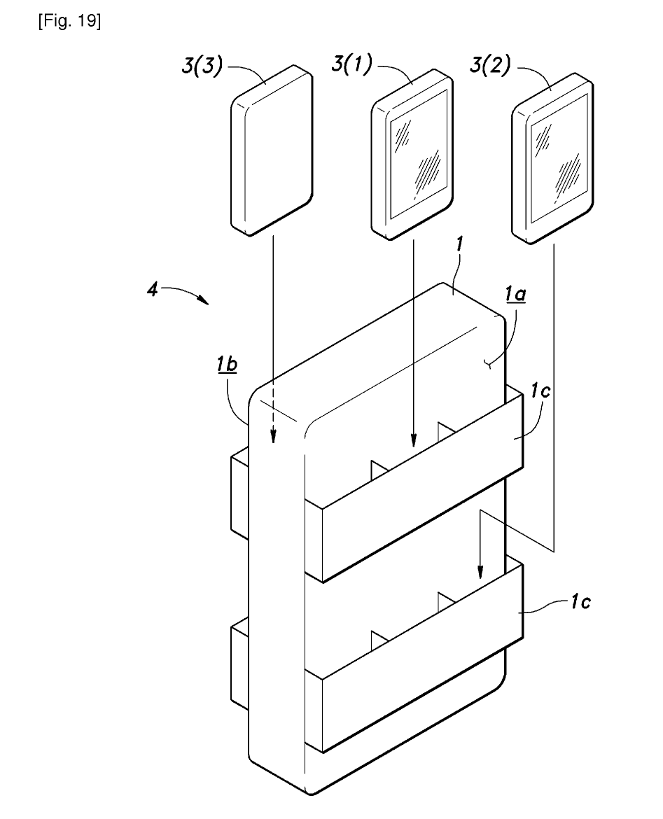

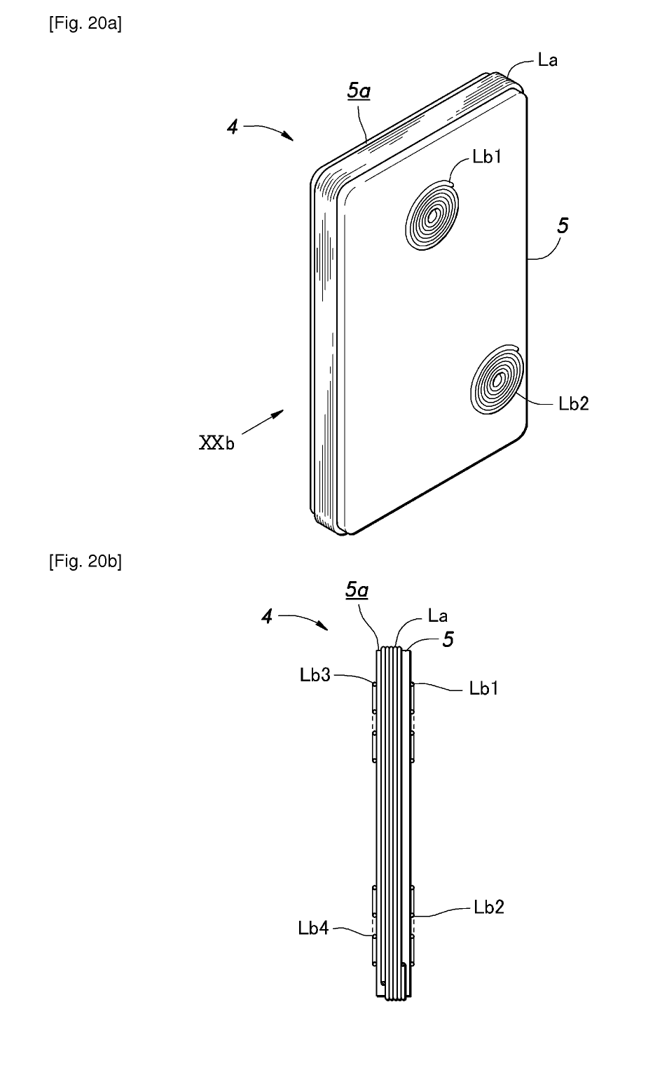

FIG. 19 is an exploded perspective view of a fourth embodiment of the present invention. The feeding table 1 of this embodiment is configured to be placed upright so that it has two table surfaces 1a and 1b extending vertically on either side thereof. FIG. 20a is a perspective view showing the positional relationship of the primary feeding coil La and the secondary receiving coils Lb1 and Lb2. FIG. 20b is a side view as seen from the direction indicated by arrow XXb in FIG. 20a. In the description of the third embodiment, the parts corresponding to those of the previous embodiments are denoted with like numerals without necessarily repeating the description of such parts.

As shown in FIGS. 20a and 20b, the primary feeding coil La is wound around the outer circumferential surface 5a of a retaining member 5 formed as a rectangular plate member. Each of the secondary receiving coils Lb is therefore required to be placed opposite to one of the vertical table surfaces 1a and 1b of the feeding table 1.

As shown in FIG. 19, two tiers of pockets 1c are formed on each side (each of the table surfaces 1a and 1b), and each tier contains three pockets arranged in a row. Each pocket 1c is provided with an upwardly directed opening from which a portable device 3 can be placed into the corresponding pocket 1c, and is configured to retain the portable device 3 such that the secondary receiving coil Lb in the portable device 3 may oppose the corresponding table surface 1a, 1b in parallel thereto at a close proximity. According to this arrangement, as the two sides of the feeding table can be used as the effective table surfaces onto which the portable devices can be placed, a large number of portable devices can be recharged at the same time for the given size of the feeding table 1. Furthermore, the vertically orienting the feeding table 1 and the portable devices 3 reduces the foot print area of the contactless electric power feeding system so that the contactless electric power feeding system can be placed in a limited space such as shop counters and small cabinets in workplaces. Furthermore, owing to the vertical orientation, foreign matters, in particular metallic pieces which may reduce the transmission efficiency are prevented from being interposed between each portable device 3 and the table surface 1a, 1b. Should any foreign matter be deposited on either table surface, it will be forced out of there by itself under the gravitational force.

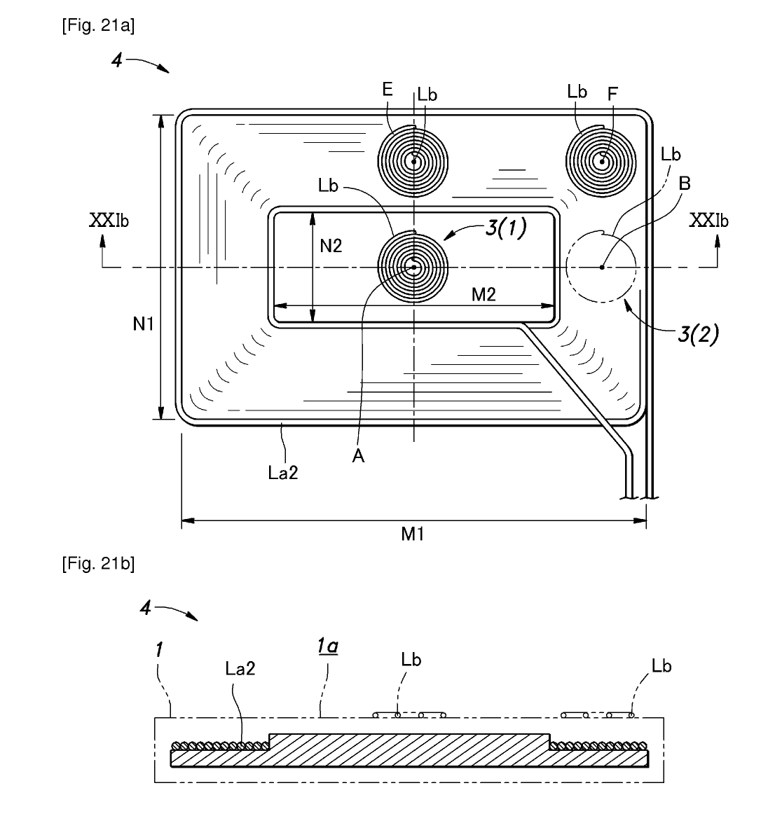

FIG. 21a is a plan view of a primary feeding coil La2 of a feeding device 4 which is given here for comparison, and FIG. 21b is a sectional view taken along line XXIb-XXIb in FIG. 21a. In the description of this example for comparison, the parts corresponding to those of the previous embodiments are denoted with like numerals without necessarily repeating the description of such parts.

This primary feeding coil La2 was formed by winding a copper wire of a 0.8 mm diameter into a spiral coil located on a single plane and having a rectangular shape as seen in plan view. The outer periphery of this primary feeding coil La2 was 240 mm (=MD in the length of the long side thereof and 160 mm (=N1) in the length (width) of the short side thereof, and the inner periphery thereof was 112 mm (=M2) in the length of the long side thereof and 51 mm (=N2) in the length (width) of the short side thereof.

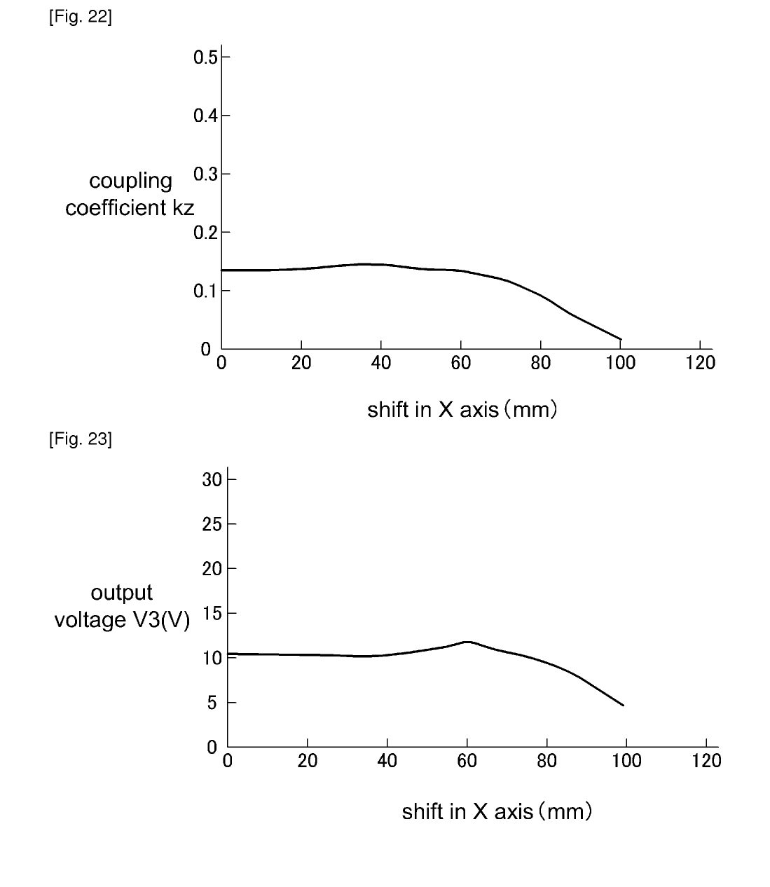

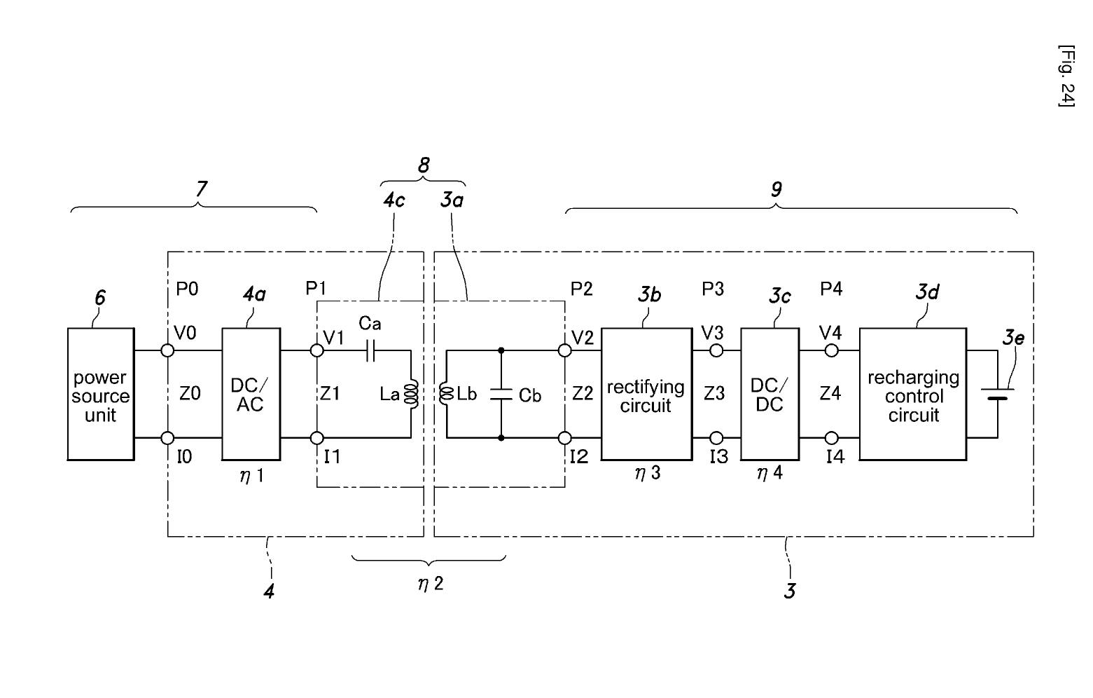

FIG. 22 shows the change in the coupling coefficient k2 between the primary feeding coil La2 and a secondary receiving coil Lb when the secondary receiving coil Lb was moved from the central position (position A or X=0) to the right along the X axis to a peripheral position (position B or X=100 mm). FIG. 23 shows the change in the output voltage (V3) of the rectifying circuit 3b when the secondary receiving coil Lb was moved in this fashion. The coupling coefficient k2 diminished toward the position B, and so did the output voltage (V3) of the rectifying circuit 3b.

When two portable devices 3(1) and 3(2) or two secondary receiving coils Lb were placed on the table surface 1a of the feeding table 1 at positions A and B as illustrated in FIG. 21a. The position A was substantially at the center of the primary feeding coil La2, and the portable device 3(1) did not overlap with the coil winding of the primary feeding coil La2 at this position. The position B was 100 mm offset to the right from the central position along the X axis, and the portable device 3(2) overlapped with the coil winding of the primary feeding coil La2 at this position. In this case, the portable device 3(1) at position A was able to receive an adequate amount of electric power 10 Watts (10 V, 1 A), but the portable device 3(2) at position B was able to receive less than one half this amount. Therefore, this feeding table 1 was not adequate for recharging multiple portable devices at the same time.

A portable device was then placed at position E which was offset from the central position in a direction perpendicular thereto and in the middle of (or overlapping with) the coil windings of the primary feeding coil La2 and at a position which was offset from position E by about 100 mm to the right along the X axis. In either case, the portable device overlaps with the coil winding of the primary feeding coil La2. In this case, the portable device was not able to receive an adequate electric power similarly as at point B. Thus, when the primary feeding coil La2 was wound into a planar spiral, and the portable device is placed so as to overlap with the coil windings of the primary feeding coil La1, the portable device was not able to receive an adequate amount of electric power.

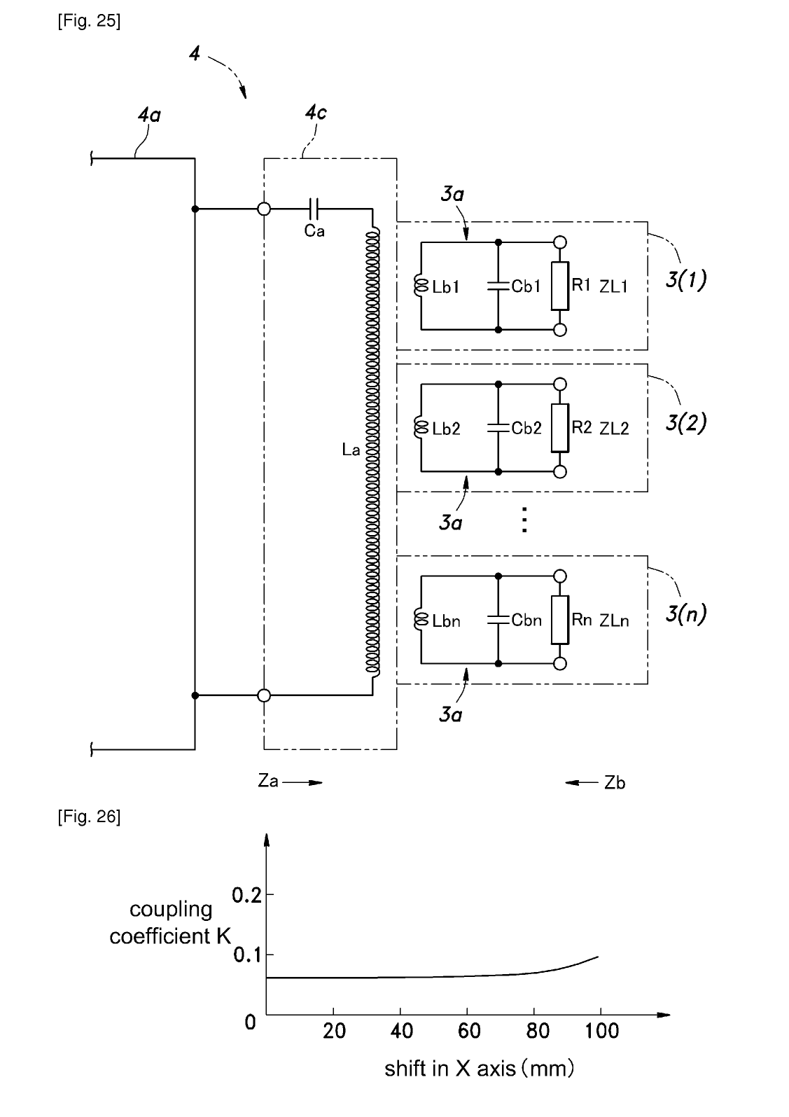

FIGS. 24 and 25 show a sixth embodiment of the present invention. In the description of the embodiment illustrated in 24 and 25, the parts corresponding to those of the embodiments illustrated in FIGS. 3, 4 and 5 are denoted with like numerals without necessarily repeating the description of such parts.

In the sixth embodiment, the LC circuit 4b of the previous embodiments is omitted, and the primary transmission circuit 4c consists of a series circuit of a primary resonance capacitor Ca and a primary feeding coil La while the secondary transmission circuit 3a consists of a parallel circuit of the secondary resonance circuit Cb and a secondary receiving coil Lb.

In this case, if the secondary load impedances of the individual portable devices 3(1)-3(n) are given by ZL1-ZLn, as the primary transmission circuit 4c consists of a series resonance circuit and the secondary transmission circuit 3a consists of a parallel resonance circuit, the overall secondary impedance Zb or the combined impedance of the portable devices can be given by the following equation.

Zb=1/{(1/ZL1)+(1/ZL2)++(1/ZLn)} Eq(3)

Eq(3) shows that the overall secondary impedance Zb decreases with the increase in the number of the secondary devices or the portable devices 3.

If the primary impedance of the electric power feeding device 4 is Za, the primary reactance Xa and the secondary reactance Xb can be given by the following equations.

Xa=Za<Sup>2</Sup>/k Eq(4)

Xb=Zb<Sup>2</Sup>*k Eq(5)

where k is the coupling coefficient between the primary feeding coil La and the secondary receiving coil Lb.

A desired impedance matching can be accomplished according to the relationships of Eq(4) and Eq(5), and the resulting impedance matching allows multi recharging to be enabled.

In regards to the circuit shown in FIGS. 24 and 25, the design principle in achieving an impedance matching is described in the following. Eta1-eta4 indicated in the diagram of FIG. 24 denote the power transmission efficiencies (%) of the DC/AC inverter 4a, the primary and secondary transmission circuits 4c and 3a, the rectifying circuit 3b and the DC/DC converter 3c. P0-P4, V0-V4, I0-I4 and Z0-Z4 denote the output powers (W), the output voltages (V), the output current (A) and the impedance (ohm) of the DC/AC inverter 4a, the primary and secondary transmission circuits 4c and 3a, the rectifying circuit 3b and the DC/DC converter 3c, respectively.

The current supplied to the load (recharging control circuit) 3d and the rechargeable battery 3e and the combined impedance thereof can be obtained from the power and voltage requirements P4 and V4 of the load 3d and the rechargeable battery 3e by the following equations, respectively.

I4=P4/V4

Z4=V4/I4

The output impedance of the DC/DC converter 3c is desired to be matched with the combined impedance Z5 of the load 3d and the rechargeable battery 3e. The output voltage of the DC/DC converter 3c is the input voltage V4 of the load 3d and the rechargeable battery 3e, the output current of the DC/DC converter 3c is the input current I4 of the load 3d and the rechargeable battery 3e, and the output power of the DC/DC converter 3c is the input power P4 of the load 3d and the rechargeable battery 3e.

As the electric power transmission efficiency of the DC/DC converter 3c is eta4, the input power P3 of the DC/DC converter 3c is given by the following equation.

P3=P4/eta4

Given the input voltage V3 of the DC/DC converter 3c, the input current I3 and the input impedance Z3 of the DC/DC converter 3c are determined by the following equations.

I3=P3/V3

Z3=V3/I3

As the power transmission coefficient (AC/DC conversion efficiency) of the rectifying circuit 3b is eta3, the input power P2 of the rectifying circuit 3b can be given by the following equation.

P2=P3/eta3

Given the input voltage V2 of the rectifying circuit 3b, the input current I2 and the input impedance Z2 of the rectifying circuit 3b are determined by the following equations.

I2=P2/V2

Z2=V2/I2

As the input impedance Z2 of the rectifying circuit 3b is required to be matched with the output impedance of the transmission circuit unit 8, the output impedance of the transmission circuit unit 8 should be Z2. As the power transmission efficiency of the transmission circuit unit 8 is eta2, the input power P1 of the transmission circuit unit 8 is given by the following equation.

P1=P2/eta2

Given the impedance Z1 of the transmission circuit unit 8, the input current I1 of the transmission circuit unit 8 is given by the following equation.

I1=SQRT(P1/Z1)

Here, SQRT(x)=x<Sup>1/2</Sup>

The input voltage V1 of the transmission circuit unit 8 is given by the following equation.

V1=SQRT(P1*Z1)

Then, the values of the circuit elements of the transmission circuit unit 8 such as L1 (inductance of the primary feeding coil La), L2 (inductance of the secondary receiving coil Lb), C1 (primary resonance capacitor) and C2 (secondary resonance capacitor) are determined.

If the input and output impedances Za and Zb of the transmission circuit unit 8 and the coupling coefficient k between the primary feeding oil La and the secondary receiving coil Lb are given, the input and output impedances Za and Zb and the resonance angular frequency omega are related to one another according to the following equations.

La=Za<Sup>2</Sup>/(omega*k)

Lb=Zb<Sup>2</Sup>*k/omega

C1=1/(La*omega<Sup>2</Sup>)

C2=1/(Lb*omega<Sup>2</Sup>)

The input and output impedances can be matched in this fashion. This impedance matching process takes into account the coupling coefficient k. As can be seen from the above equations, the inductance La depends on the input end impedance Za and the coupling coefficient k. The coupling coefficient k is obtained from the inductances La and Lb. Therefore, the primary inductance La depends on the secondary inductance Lb. Likewise, the secondary inductance Lb depends on the output end impedance Zb and the coupling coefficient k as well as on the primary inductance La. FIG. 25 shows a case of impedance matching where a plurality of portable devices 3(1)-3(n) are placed on the feeding device 1 at the same time, but there may be only one portable device 1 to be recharged. In the latter case or when there is only one portable device 3(1), Zb=ZL1.

When the output power, the output voltage and the output current of the DC/AC inverter 4a are P1, V1 and I1, respectively, and the power transmission efficiency of the DC/AC inverter 4a is eta1, the input power P0 of the DC/AC inverter 4a or the electric power supplied by the power source unit 6 can be given by the following equation.

P0=P1/eta1

The impedance of the DC/AC inverter 4a is typically very low, close to zero ohm as most AC power sources are. The output power P1 of the DC/AC inverter 4a can be determined from the output voltage (RMS or effective value) V1 of the DC/AC inverter 4a and the input impedance Z1 of the LC circuit 4b according to the following equation.

P1=V1<Sup>2</Sup>/Z1

Hence, the output voltage V1 is given by the following equation.

V1=SQRT(P1*Z1)

In the case of a half bridge circuit, the effective value of the voltage V1 is one half of the power source voltage V0 or

V1=V0/2

The power supply at the source voltage V0 is given by the following equation.

P1=V0<Sup>2</Sup>/(4*Z1)

This arrangement was tested by using the primary feeding coil and the secondary receiving coils similar to those used for testing the first and second embodiments.

The secondary transmission coil Lb was moved from a central position (position A or X=0) to a peripheral position (position B or X=100 mm) (as shown in FIG. 7). FIG. 26 shows the change in the coupling coefficient k as the secondary transmission coil Lb was moved from position A to position B. As can be seen from FIG. 26, there was very little change in the coupling coefficient k substantially without regard to the position of the secondary transmission coil Lb in the primary transmission coil La. Because the input and output impedances of the transmission circuit unit 8 are matched by using the coupling coefficient k which does not change no matter where the portable device is placed, the matching of the input and output impedances can be maintained substantially under any conditions. Therefore, even when the coupling coefficient k is low (0.1 or less) as shown in FIG. 26, electric power can be transmitted in an efficient manner.

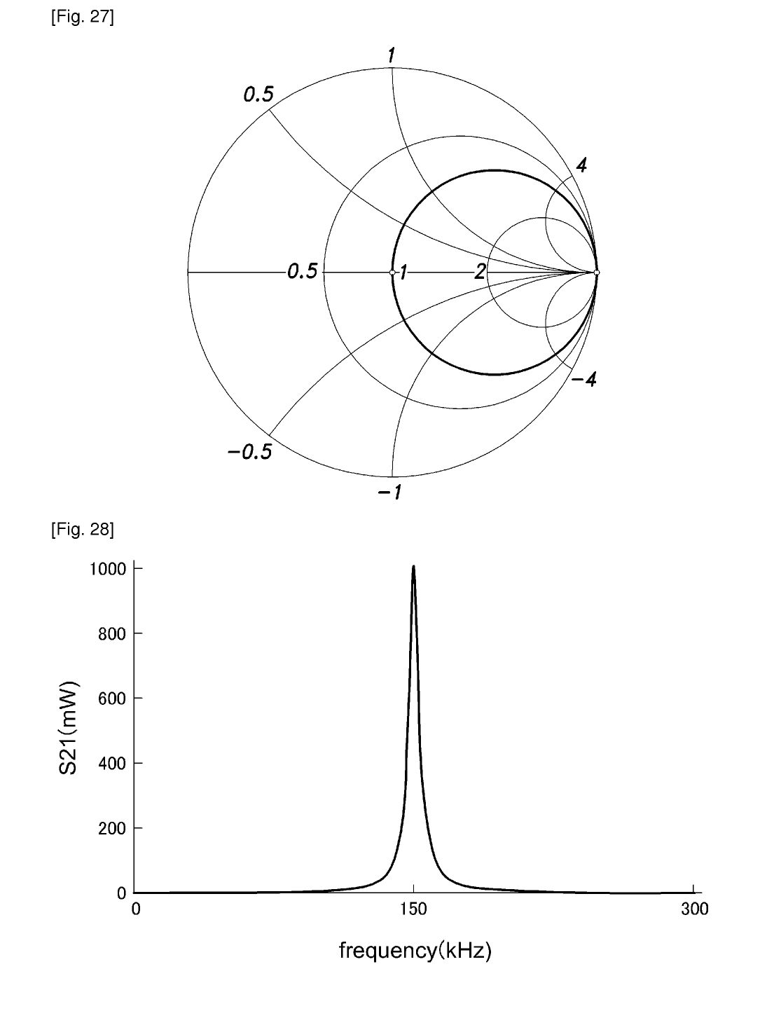

FIG. 27 is a Smith chart showing the properties of the impedance Za of the primary transmission circuit 4c (normalized by 10 ohms) as seen from the primary side of the primary transmission circuit 4c when the secondary transmission coil Lb was placed substantially in the center (position A). It shows the properties of the impedance Za of the primary transmission circuit 4c as seen from the end of the power feeding circuit unit 7.

The transmission properties are shown in FIG. 28. In this case, a matching was made between the primary impedance Za and the secondary impedance Zb which were 10 ohms. The abscissa is the transmission frequency (kHz) and the ordinate is the transmission power (mW). As can be seen from the transmission properties shown in this graph, the received electric power P2 was 1,000 mW when the feeding electric power was 1 W at the frequency of 150 kH, and this means that an adequate supply of electric power can be transmitted for recharging the portable device 3. This owes to the favorable impedance matching, and it was demonstrated that a favorable electric transmission can be achieved when a series resonance circuit is used for the feeder table 1 and a parallel resonance circuit is used for the portable device 3.

When a proper impedance matching is achieved, power transmission between the two coils is so effective that this arrangement can be favorably applied to a contactless power transmission system. Furthermore, the size of the secondary coil Lb can be made highly compact so that this arrangement allows the use of highly compact portable devices.

By using a vertical helical coil for the primary feeding coil La and taking an impedance matching between the primary feeding coil and the secondary receiving coil(s), even when a plurality of secondary receiving coils Lb1-Lbn are placed on the primary feeding coil La, each secondary receiving coil can benefit from a substantially equal power transmission properties, and it was demonstrated that a favorable multi recharging can be accomplished.

When the values of the circuit parameters such as the resonance condition, the coupling coefficient and the input and output impedances of the transmission circuit unit 8 are properly selected, it is possible to arrive at a design point where the theoretical efficiency (disregarding the losses of the coils) of almost 100% can be achieved. If an appropriate impedance matching is made between the primary feeding coil La and the secondary receiving coil(s) Lb, the increase in the load (on the secondary side) as seen from the primary side is simply additive so that the design of the inverter circuit can be simplified.

In this case also, it is preferable that the length N of the short side of the primary feeding coil La is no more than four times the outer diameter Q of the secondary receiving coil Lb (N &lt;=4Q), and the length M of the long side of the primary feeding coil La is no more than six times the outer diameter Q of the secondary receiving coil Lb (M &lt;=6Q). It was also observed that more favorable results can be obtained if the length N of the short side of the primary feeding coil La is no more than three times the outer diameter Q of the secondary receiving coil Lb (N &lt;=3Q), and the length M of the long side of the primary feeding coil La is no more than five times the outer diameter Q of the secondary receiving coil Lb (M &lt;=5Q). Most preferably, the length N of the short side of the primary feeding coil La is no more than twice the outer diameter Q of the secondary receiving coil Lb, and the length M of the long side of the primary feeding coil La is no more than three times the outer diameter Q of the secondary receiving coil Lb.

This embodiment can also be applied to the coil arrangements shown in FIGS. 18 to 20.

As a second example of comparison, an arrangement similar to the sixth embodiment was constructed and tested. In the second example, the coupling coefficient k between the primary feeding coil and the secondary receiving coil, the resonance frequency f, the inductance of the primary feeding coil La and the capacitance of the first resonance capacitor Ca were the same as those of the sixth embodiment, but the inductance (inductive reactance) of the secondary receiving coil Lb was one half of that of the sixth embodiment. To realize the same resonance frequency, the capacitance (capacitive reactance) of the second resonance capacitor Cb was twice that of the sixth embodiment.

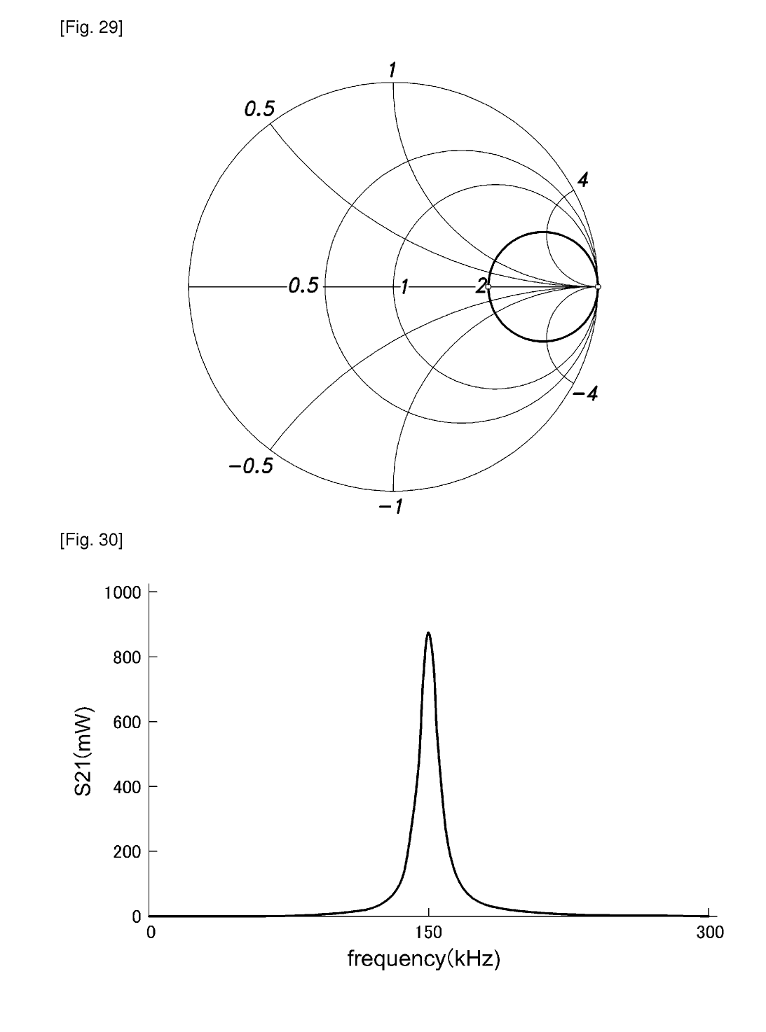

The Smith chart for this arrangement (the second example for comparison) is shown in FIG. 29. In this case, the impedance of the primary end (input end) was 20 ohms while the impedance of the secondary end (output end) was 5 ohms, and an impedance matching was not achieved.

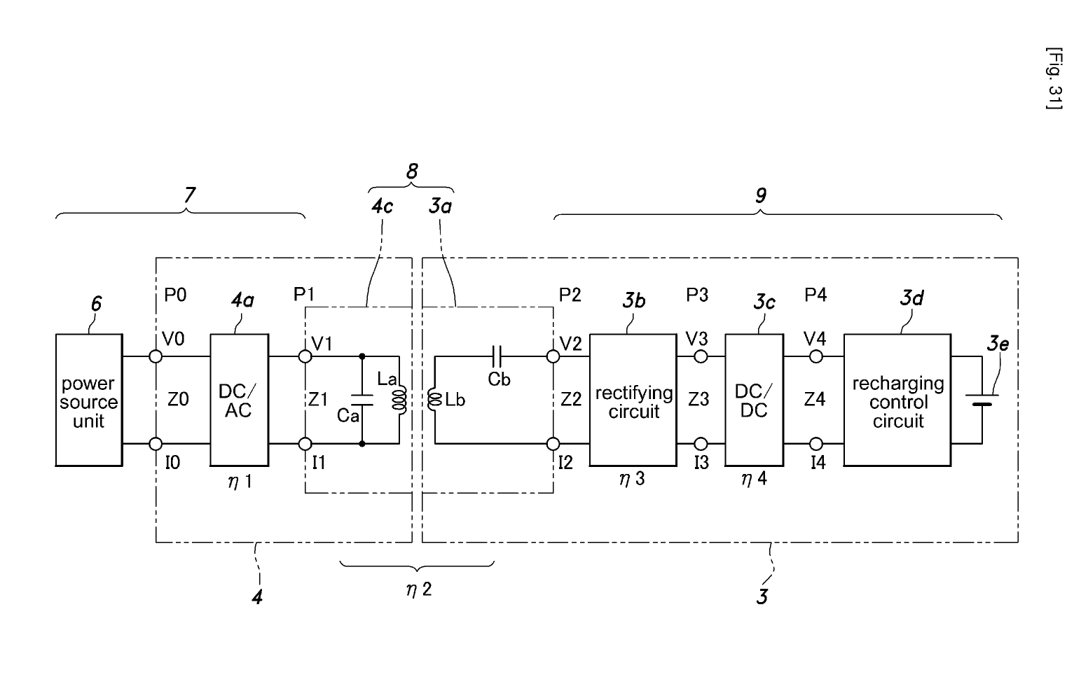

The transmission properties of the second example for comparison are shown in FIG. 30. In this case, a matching was not made between the primary impedance Za and the secondary impedance Zb, and S21 (transmission property) was reduced to about 890 mW, which is normally inadequate for recharging the portable device 3.

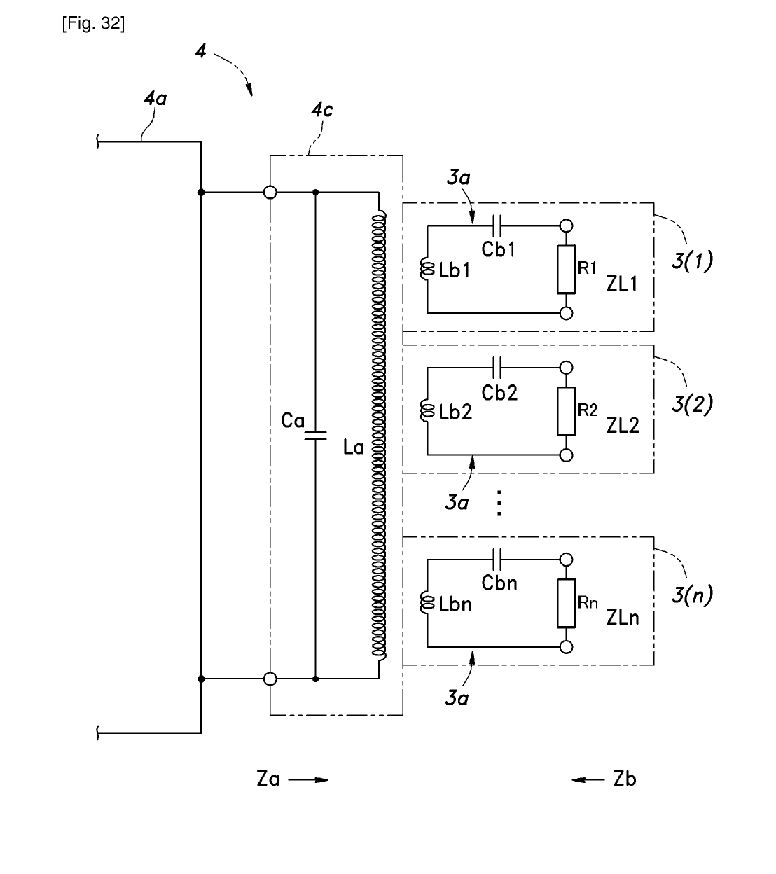

FIGS. 31 and 32 show a seventh embodiment of the present invention. In the description of the embodiment illustrated in FIGS. 31 and 32, the parts corresponding to those of the embodiments illustrated in FIGS. 3, 4, 5, 24 and 25 are denoted with like numerals without necessarily repeating the description of such parts.

In the seventh embodiment, the LC circuit 4b is omitted, and the primary transmission circuit 4c consists of a parallel circuit of a primary resonance capacitor Ca and a primary feeding coil La while the secondary transmission circuit 3a consists of a series circuit of the secondary resonance circuit Cb and a secondary receiving coil Lb.

In this case, if the secondary load impedances of the individual portable devices 3(1)-3(n) are given by ZL1-ZLn, as the primary transmission circuit 4c consists of a parallel resonance circuit and the secondary transmission circuit 3a consists of a series resonance circuit, the overall secondary impedance Zb or the combined impedance of the portable devices can be given by the following equation.

Zb=1/{(1/ZL1)+(1/ZL2)+ . . . +(1/ZLn)} Eq(6)

Eq(3) shows that the overall secondary impedance Zb decreases with the increase in the number of the secondary devices or the portable devices 3.

If the primary impedance of the electric power feeding device 4 is Za, the primary reactance Xa and the secondary reactance Xb can be given by the following equations.

Xa=Za<Sup>2</Sup>*k Eq(7)

Xb=Zb<Sup>2</Sup>/k Eq(8)

where k is the coupling coefficient between the primary feeding coil La and the secondary receiving coil Lb.

A desired impedance matching can be accomplished according to the relationships of Eq(7) and Eq(8), and the resulting impedance matching allows multi recharging to be enabled.

In regards to the circuit shown in FIGS. 31 and 32, the design principle in achieving an impedance matching is described in the following. Eta1-eta4 indicated in the diagram of FIG. 31 denote the power transmission efficiencies (%) of the DC/AC inverter 4a, the primary and secondary transmission circuits 4c and 3a, the rectifying circuit 3b and the DC/DC converter 3c. P0-P4, V0-V4, I0-I4 and Z0-Z4 denote the output powers (W), the output voltages (V), the output current (A) and the impedance (ohm) of the DC/AC inverter 4a, the primary and secondary transmission circuits 4c and 3a, the rectifying circuit 3b and the DC/DC converter 3c, respectively.

The current supplied to the load (recharging control circuit) 3d and the rechargeable battery 3e and the combined impedance thereof can be obtained from the power and voltage requirements P4 and V4 of the load 3d and the rechargeable battery 3e by the following equations, respectively.

I4=P4/V4

Z4=V4/I4

The output impedance of the DC/DC converter 3c is desired to be matched with the combined impedance Z5 of the load 3d and the rechargeable battery 3e. The output voltage of the DC/DC converter 3c is the input voltage V4 of the load 3d and the rechargeable battery 3e, the output current of the DC/DC converter 3c is the input current I4 of the load 3d and the rechargeable battery 3e, and the output power of the DC/DC converter 3c is the input power P4 of the load 3d and the rechargeable battery 3e.

As the electric power transmission efficiency of the DC/DC converter 3c is eta4, the input power P3 of the DC/DC converter 3c is given by the following equation.

P3=P4/eta4

Given the input voltage V3 of the DC/DC converter 3c, the input current I3 and the input impedance Z3 of the DC/DC converter 3c are determined by the following equations.

I3=P3/V3

Z3=V3/I3

As the power transmission coefficient (AC/DC conversion efficiency) of the rectifying circuit 3b is eta3, the input power P2 of the rectifying circuit 3b can be given by the following equation.

P2=P3/eta3

Given the input voltage V2 of the rectifying circuit 3b, the input current I2 and the input impedance Z2 of the rectifying circuit 3b are determined by the following equations.

I2=P2/V2

Z2=V2/I2

As the input impedance Z2 of the rectifying circuit 3b is required to be matched with the output impedance of the transmission circuit unit 8, the output impedance of the transmission circuit unit 8 should be Z2. As the power transmission efficiency of the transmission circuit unit 8 is eta2, the input power P1 of the transmission circuit unit 8 is given by the following equation.

P1=P2/eta2

Given the impedance Z1 of the transmission circuit unit 8, the input current I1 of the transmission circuit unit 8 is given by the following equation.

I1=SQRT(P1/Z1)

Here, SQRT(x)=x<Sup>1/2</Sup>

The input voltage V1 of the transmission circuit unit 8 is given by the following equation.

V1=SQRT(P1*Z1)

Then, the values of the circuit elements of the transmission circuit unit 8 such as L1 (inductance of the primary feeding coil La), L2 (inductance of the secondary receiving coil Lb), C1 (primary resonance capacitor) and C2 (secondary resonance capacitor) are determined.

If the input and output impedances Za and Zb of the transmission circuit unit 8 and the coupling coefficient k between the primary feeding oil La and the secondary receiving coil Lb are given, the input and output impedances Za and Zb and the resonance angular frequency omega are related to one another according to the following equations.

La=Za/(omega*k)

Lb=Zb/(omega*k)

C1=1/(La*omega<Sup>2</Sup>)

C2=1/(Lb*omega<Sup>2</Sup>)

The input and output impedances can be matched in this fashion. This impedance matching process takes into account the coupling coefficient k. As can be seen from the above equations, the inductance La depends on the input end impedance Za and the coupling coefficient k. The coupling coefficient k is obtained from the inductances La and Lb. Therefore, the primary inductance La depends on the secondary inductance Lb. Likewise, the secondary inductance Lb depends on the output end impedance Zb and the coupling coefficient k as well as on the primary inductance La. FIG. 32 shows a case of impedance matching where a plurality of portable devices 3(1)-3(n) are placed on the feeding device 1 at the same time, but there may be only one portable device 1 to be recharged. In the latter case or when there is only one portable device 3(1), Zb=ZL1.

When the output power, the output voltage and the output current of the DC/AC inverter 4a are P1, V1 and I1, respectively, and the power transmission efficiency of the DC/AC inverter 4a is eta1, the input power P0 of the DC/AC inverter 4a or the electric power supplied by the power source unit 6 can be given by the following equation.

P0=P1/eta1

The impedance of the DC/AC inverter 4a is typically very low, close to zero ohm as most AC power sources are. The output power P1 of the DC/AC inverter 4a can be determined from the output voltage (RMS or effective value) V1 of the DC/AC inverter 4a and the input impedance Z1 of the LC circuit 4b according to the following equation.

P1=V1<Sup>2</Sup>/Z1

Hence, the output voltage V1 is given by the following equation.

V1=SQRT(P1*Z1)

In the case of a half bridge circuit, the effective value of the voltage V1 is one half of the power source voltage V0 or

V1=V0/2

The power supply at the source voltage V0 is given by the following equation.

P1=V0<Sup>2</Sup>/(4*Z1)

This arrangement was tested by using the primary feeding coil and the secondary receiving coils similar to the one used for testing the first and second embodiments.

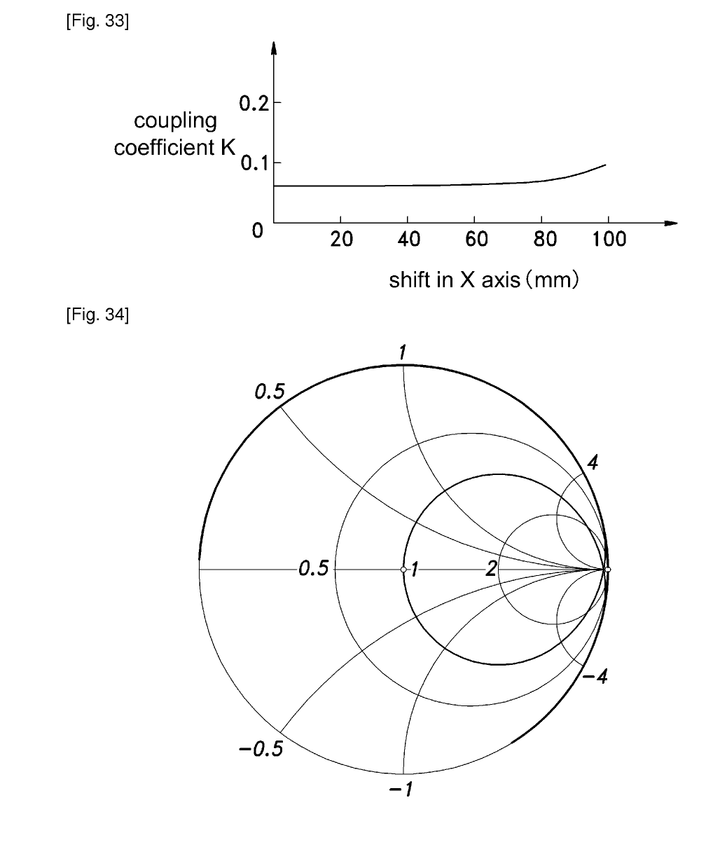

The secondary transmission coil Lb was moved from a central position (position A or X=0) to a peripheral position (position B or X=100 mm) (as shown in FIG. 7). FIG. 33 shows the change in the coupling coefficient k as the secondary transmission coil Lb was moved from position A to position B. As can be seen from FIG. 33, there was very little change in the coupling coefficient k substantially without regard to the position of the secondary transmission coil Lb in the primary transmission coil La. Because the input and output impedances of the transmission circuit unit 8 are matched by using the coupling coefficient k which does not change no matter where the portable device is placed, the matching of the input and output impedances can be maintained substantially under any conditions. Therefore, even when the coupling coefficient k is low (0.1 or less) as shown in FIG. 33, electric power can be transmitted in an efficient manner.

FIG. 34 is a Smith chart showing the properties of the impedance Za of the primary transmission circuit 4c (normalized by 10 ohms) as seen from the primary side of the primary transmission circuit 4c when the secondary transmission coil Lb was placed substantially in the center (position A). It shows the properties of the impedance Za of the primary transmission circuit 4c as seen from the end of the power feeding circuit unit 7.

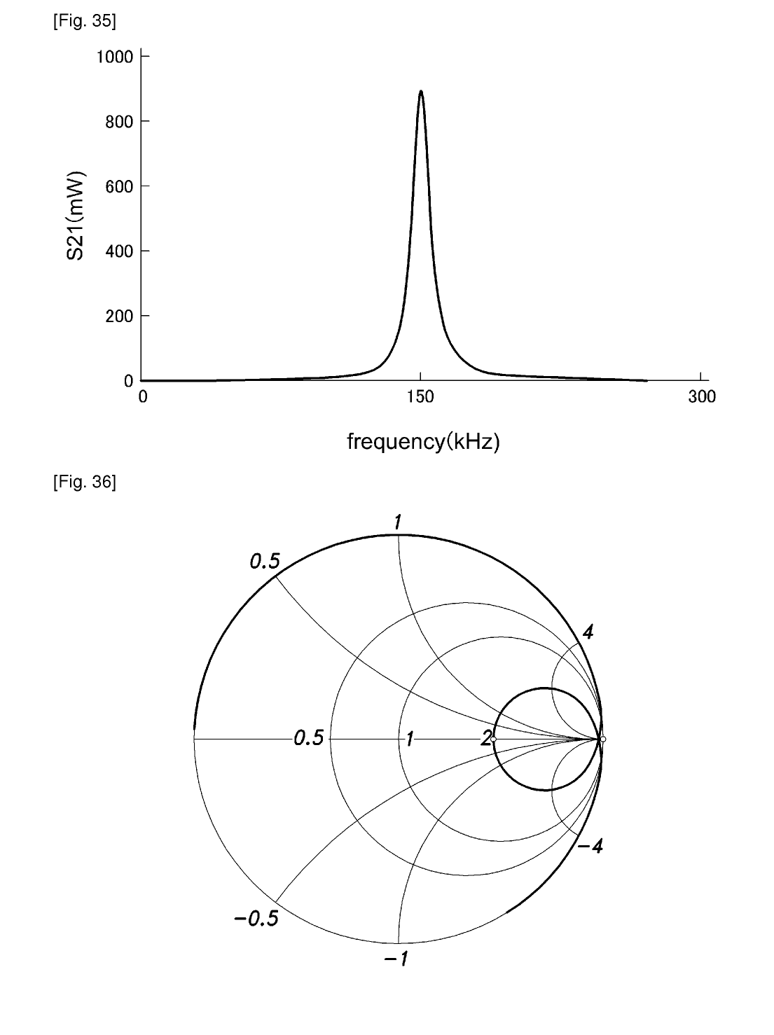

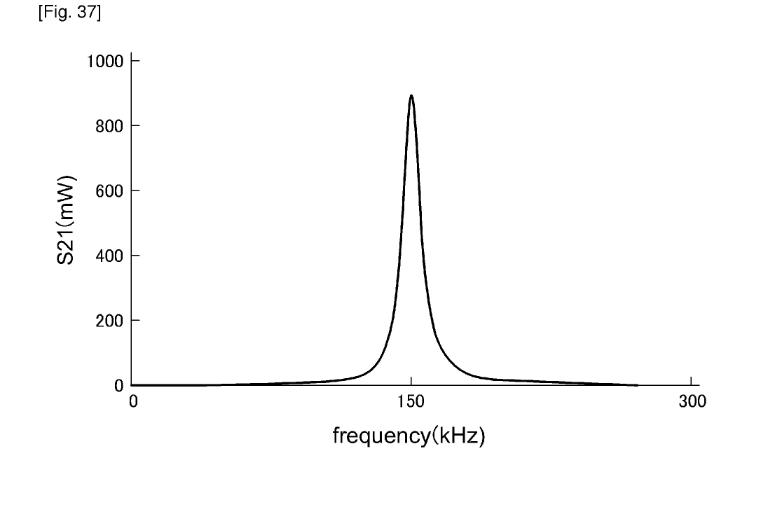

The transmission properties are shown in FIG. 35. In this case, a matching was made between the primary impedance Za and the secondary impedance Zb which were 10 ohms. The abscissa is the transmission frequency (kHz) and the ordinate is the transmission power (mW). As can be seen from the transmission properties shown in this graph, the received electric power P2 was 1,000 mW when the feeding electric power was 1 W at the frequency of 150 kH, and this means that an adequate supply of electric power can be transmitted for recharging the portable device 3. This owes to the favorable impedance matching, and it was demonstrated that a favorable electric transmission can be achieved when a series resonance circuit is used for the feeder table 1 and a parallel resonance circuit is used for the portable device 3.

When a proper impedance matching is achieved, power transmission between the two coils is so effective that this arrangement can be favorably applied to a contactless power transmission system. Furthermore, the size of the secondary coil Lb can be made highly compact so that this arrangement allows the use of highly compact portable devices.

By using a vertical helical coil for the primary feeding coil La and taking an impedance matching between the primary feeding coil and the secondary receiving coil(s), even when a plurality of secondary receiving coils Lb1-Lbn are placed on the primary feeding coil La, each secondary receiving coil can benefit from a substantially equal power transmission properties, and it was demonstrated that a favorable multi recharging can be accomplished.

When the values of the circuit parameters such as the resonance condition, the coupling coefficient and the input and output impedances of the transmission circuit unit 8 are properly selected, it is possible to arrive at a design point where the theoretical efficiency (disregarding the losses of the coils) of almost 100% can be achieved. If an appropriate impedance matching is made between the primary feeding coil La and the secondary receiving coil(s) Lb, the increase in the load (on the secondary side) as seen from the primary side is simply additive so that the design of the inverter circuit can be simplified.

In this case also, it is preferable that the length N of the short side of the primary feeding coil La is no more than four times the outer diameter Q of the secondary receiving coil Lb (N &lt;=4Q), and the length M of the long side of the primary feeding coil La is no more than six times the outer diameter Q of the secondary receiving coil Lb (M &lt;=6Q). It was also observed that more favorable results can be obtained if the length N of the short side of the primary feeding coil La is no more than three times the outer diameter Q of the secondary receiving coil Lb (N &lt;=3Q), and the length M of the long side of the primary feeding coil La is no more than five times the outer diameter Q of the secondary receiving coil Lb (M &lt;=5Q). Most preferably, the length N of the short side of the primary feeding coil La is no more than twice the outer diameter Q of the secondary receiving coil Lb, and the length M of the long side of the primary feeding coil La is no more than three times the outer diameter Q of the secondary receiving coil Lb.

This embodiment can also be applied to the coil arrangements shown in FIGS. 18 to 20.

As a third example of comparison, an arrangement similar to the seventh embodiment was constructed and tested. In the third example, the coupling coefficient k between the primary feeding coil and the secondary receiving coil, the resonance frequency f, the inductance of the primary feeding coil La and the capacitance of the first resonance capacitor Ca were the same as those of the seventh embodiment, but the inductance (inductive reactance) of the secondary receiving coil Lb was one half of that of the sixth embodiment. To realize the same resonance frequency, the capacitance (capacitive reactance) of the second resonance capacitor Cb was twice that of the seventh embodiment.

The Smith chart for this arrangement (the third example for comparison) is shown in FIG. 36. In this case, the impedance of the primary end (input end) was 20 ohms while the impedance of the secondary end (output end) was 5 ohms, and an impedance matching was not achieved.

The transmission properties of the second example for comparison are shown in FIG. 36. In this case, a matching was not made between the primary impedance Za and the secondary impedance Zb, and S21 (transmission property) was reduced to about 890 mW, which is normally inadequate for recharging the portable device 3.

In the following is summarized the theoretical background of the present invention. Depending on the series and parallel configurations of the primary transmission circuit 3a and the secondary transmission circuit 3b, the transmission circuit unit 8 is designed such that one of the following relationships holds.

omega*La=Za/k,omega*Lb=Zb/k (1)

omega*La=Za*k,omega*Lb=Zb*k (2)

omega*La=Za<Sup>2</Sup>/k,omega*Lb=Zb<Sup>2</Sup>*k (3)

omega*La=Za<Sup>2</Sup>*k,omega*Lb=Zb<Sup>2</Sup>/k (4)

An impedance matching can be made when one of these relationships holds in the corresponding arrangement of the transmission circuit unit. Therefore, even when the coupling coefficient is small (less than 0.1, for instance), electric power can be transmitted at a high efficiency.

As can be seen from these equations, the primary self inductance La depends on the input impedance Za and the coupling coefficient k. The coupling coefficient k can be obtained from the primary and secondary inductances La and Lb. Therefore, the primary inductance La depends on the secondary inductance Lb. Likewise, the conductance Lb depends on the output impedance Zb and the coupling coefficient k, and hence depends on the primary inductance La.

The primary feeding coil La can be a coil of any configuration, but preferably consists of a vertical helical coil. In the case of a planar coil such as the primary feeding coil La2 illustrated in FIGS. 21a and 21b, the coupling coefficient k changes significantly depending on the positional relationship between the secondary receiving coil Lb and the primary feeding coil La2 as shown in FIG. 22. This is due to the fact that the magnetic field of a planar coil is generally uneven, and is stronger in the middle part than in the peripheral part of the coil. The input and output impedances of the transmission circuit unit 8 are matched by using the coupling coefficient k. Therefore, as shown in FIG. 23 in combination with FIG. 22, the output voltage V3 decreases depending on the coupling coefficient k. For instance, the optimum self inductances of the primary feeding coil La2 and the secondary receiving coil are computed by using the coupling coefficient k when the secondary receiving coil Lb is located in position A, the transmission efficiency drops sharply when the secondary receiving coil Lb is placed in position B of FIG. 21. In other words, the region of the primary feeding coil La2 in which the secondary receiving coil La may be placed is limited, and the position free recharging of the portable devices cannot be achieved.

In the embodiment illustrated in FIGS. 1 and 2, the primary feeding coil La consists of a vertical helical coil formed by winding an electro-conductive wire in a helical configuration around a central axial line such that one ascends or descends as one moves along the electro-conductive wire as in a spiral stairway. In this case, there is very little change in the coupling coefficient k when the position of the secondary receiving coil Lb is varied within the primary feeding coil (see FIG. 7). Therefore, even when the position of the secondary receiving coil Lb is varied, the impedance matching at the input and output ends can be substantially maintained. Therefore, the output voltage V3 can be supplied in a stable manner. In other words, the region of the primary feeding coil La in which the secondary receiving coil La may be placed is not limited, and the position free recharging of the portable devices can be achieved.

The significance of the LC circuit 4b which was used in some of the embodiments is discussed in the following. When the portable device 3 is placed in a peripheral part of the feeding device 4, the primary impedance Za increases. The greater the number of the portable devices is, the greater the increase in the primary impedance Za is.

When the primary impedance Za has increased in this manner, and there is no LC circuit 4b between the DC/AC inverter 4a and the primary transmission circuit 4c (or electric power is directly supplied from the DC/AC inverter 4a to the primary transmission circuit 4c), the impedance Z1 of the output end of the DC/AC inverter 4a corresponds to the primary impedance Za.

As discussed earlier, the output power P1 of the DC/AC inverter 4a depends on the impedance Z1 of the output end of the DC/AC inverter 4a according to the following relationship.

P1=V1<Sup>2<Sup>/Z1

Therefore, the greater the impedance Z1 is, the smaller the output power P1 of the DC/AC inverter 4a becomes. As a result, the power that can be transmitted to the portable devices decreases.

The LC circuit 4b is connected to the output end of the DC/AC inverter 4a to decrease the impedance Z1 of the output end of the DC/AC inverter 4a. Thereby, the decrease in the output power P1 of the DC/AC inverter 4a can be avoided, and the reduction of the power that can be transmitted to the portable devices can be minimized.

The LC circuit 4b is only one fox in of the impedance control circuit, and may consist of any other circuit that can adjust the impedance between the DC/AC inverter 4a and the primary transmission circuit 4c as long as the impedance Z1 of the output end of the DC/AC inverter 4a can be made smaller than the input impedance Z2 of the transmission circuit unit 8 in FIG. 3.

The impedance Z1 is the impedance of the impedance control circuit as seen from the side of the DC/AC inverter 4a. The impedance Z2 is the impedance of the transmission circuit unit 8 as seen from the side of the impedance control circuit, as well as the input impedance of the transmission circuit unit 8.

The foregoing embodiments are effective also when there is only one portable device or power receiving device. For instance, the impedance control circuit is effective in reducing the decrease in the output power of the DC/AC inverter 4a even when there is only one power receiving device. The fact that the impedance matching of the output and input impedances of the power transmission circuit unit 8 is effected by taking into account the coupling coefficient k also contributes to the reduction in the efficiency in transmitting electric power to power receiving devices.

Although the present invention has been described in terms of preferred embodiments thereof, it is obvious to a person skilled in the art that various alterations and modifications are possible without departing from the scope of the present invention which is set forth in the appended claims.

1. A contactless electric power feeding device for feeding electric power to a power receiving device including a secondary receiving coil, comprising:
a primary feeding coil;
an impedance control circuit electrically connected to the primary feeding coil; and
a power supply unit configured to supply electric power to the primary feeding coil via the impedance control circuit;
wherein a first impedance of an input end of a transmission circuit unit including the primary feeding coil and the second receiving coil is matched with a second impedance of an output end of the transmission circuit unit by using a coupling efficient between the primary feeding coil and the secondary receiving coil, and the output impedance of the power supply unit is smaller than the first impedance.

2. The electric power feeding device according to claim 1, wherein a first inductance of the primary feeding coil is determined from the coupling efficient between the primary feeding coil and the secondary receiving coil.

3. The electric power feeding device according to claim 2, wherein the first inductance is determined from a second inductance of the secondary receiving coil.

4. The electric power feeding device according to claim 3, wherein the first inductance is determined from the second impedance.

5. The electric power feeding device according to claim 1, wherein the primary feeding coil comprises a helical coil.

6. The electric power feeding device according to claim 1, wherein the impedance control circuit comprises a coil and a capacitor.

7. A contactless electric power feeding system for feeding electric power from a power feeding device to a power receiving device, comprising:
a transmission circuit unit including a primary feeding coil and a secondary receiving coil;
an impedance control circuit electrically connected to the primary feeding coil;
a power supply unit configured to supply electric power to the primary feeding coil via the impedance control circuit; and
a power receiving circuit for receiving electric power from the secondary receiving circuit;
wherein a first impedance of an input end of the transmission circuit unit is matched with a second impedance of an output end of the transmission circuit unit by using a coupling efficient between the primary feeding coil and the secondary receiving coil, and the output impedance of the power supply unit is smaller than the first impedance.

8. The electric power feeding system according to claim 7, wherein the transmission circuit unit further comprises a primary capacitor connected in series with the primary feeding coil to form a series resonance circuit and a secondary capacitor connected in series with the secondary receiving coil to form another series resonance circuit.

9. The electric power feeding system according to claim 8, wherein the power supply unit supplies an AC electric power with an angular frequency of omega to the primary feeding coil, and the following relationships hold
omega*L1=Z1/k
omega*L2=Z2/k
where
L1 is an inductance of the primary feeding coil,
L2 is an inductance of the secondary receiving coil Lb,
Z1 is the first impedance,
Z2 is the second impedance and
k is the coupling coefficient.

10. The electric power feeding system according to claim 7, wherein the transmission circuit unit further comprises a primary capacitor connected in parallel with the primary feeding coil to form a parallel resonance circuit and a secondary capacitor connected in parallel with the secondary receiving coil to form another parallel resonance circuit.

11. The electric power feeding system according to claim 8, wherein the power supply unit supplies an AC electric power with an angular frequency of omega to the primary feeding coil, and the following relationships hold
omega*L1=Z1*k
omega*L2=Z2*k
where
L1 is an inductance of the primary feeding coil,
L2 is an inductance of the secondary receiving coil Lb,
Z1 is the first impedance,
Z2 is the second impedance and
k is the coupling coefficient.

12. The electric power feeding system according to claim 7, wherein the primary feeding coil comprises a helical coil.

13. The electric power feeding system according to claim 12, wherein the secondary receiving coil is wound around an axial line substantially in parallel with an axial line of the helical coil.

14. The electric power feeding system according to claim 7, wherein the impedance control circuit comprises a coil and a capacitor.

15. A contactless electric power feeding system for feeding electric power from a power feeding device to a power receiving device, comprising:
a transmission circuit unit including a primary feeding coil and a secondary receiving coil;
a power supply unit configured to supply electric power to the primary feeding coil via the impedance control circuit; and
a power receiving circuit for receiving electric power from the secondary receiving circuit;
wherein a first impedance of an input end of the transmission circuit unit is matched with a second impedance of an output end of the transmission circuit unit by using a coupling efficient between the primary feeding coil and the secondary receiving coil, and the transmission circuit unit further comprises a primary capacitor connected in series with one of the primary feeding coil and the secondary receiving coil to form a series resonance circuit and a secondary capacitor connected in parallel with the other of the primary feeding coil and the secondary receiving coil to form a parallel resonance circuit.
